(19) United States
(12) Patent Application Publication
(10) Pub. No.: US 2026/0025215 A1
(43) Pub. Date: Jan. 22, 2026

(54) IDLE-MODE BEAM MEASUREMENT AND REPORTING TO TRAIN ARTIFICIAL INTELLIGENCE LEARNING MODELS

(71) Applicant: Dell Products L.P., Round Rock, TX (US)

(72) Inventor: Ali Esswie, Calgary (CA)

(21) Appl. No.: 18/774,572

(22) Filed: Jul. 16, 2024

(51) Int. Cl. H04B 17/318; H04B 7/0408; H04W 24/10

(52) U.S. Cl. CPC H04B 17/318; H04B 7/0408; H04W 24/10

(57) ABSTRACT

A radio network node transmits beam reporting configuration information indicative of measurement beams. User equipment receive the information and measure signals transmitted via the measurement beams. The user equipment transmits measured measurement beam signal values to the node via an existing connection, or if the user equipment is idle, via a special-purpose connection established in response to a request by the user equipment. An idle user equipment may avoid requesting a special-purpose connection if a difference between a measured measurement beam signal value and a measured synchronization signal block signal value does not exceed a reporting criterion. The node may analyze measured signal values received from the user equipment using a learning model to determine a refined delivery beam usable to deliver traffic to the user equipment, and may analyze a measured signal value, reported by the user equipment, corresponding to the delivery beam to determine a different delivery beam.

### REFERENCE TO RELATED APPLICATIONS

The subject patent application is related to U.S. patent application Ser. No.______, filed______, and entitled “CONNECTED-MODE AI-DRIVEN BEAM MANAGEMENT AND DYNAMIC REPORTING” and U.S. patent application No.______, filed______, and entitled “IDLE BEAM ARTIFICIAL INTELLIGENCE LEARNING MODEL TRAINING”, the entireties of which applications are hereby incorporated by reference herein.

### BACKGROUND

The ‘New Radio’ (NR) terminology that is associated with fifth generation mobile wireless communication systems (“5G”) refers to technical aspects used in wireless radio access networks (“RAN”) that comprise several quality of service classes (QoS), including ultrareliable and low latency communications (“URLLC”), enhanced mobile broadband (“eMBB”), and massive machine type communication (“mMTC”). The URLLC QoS class is associated with a stringent latency requirement (e.g., low latency or low signal/message delay) and a high reliability of radio performance, while conventional eMBB use cases may be associated with high-capacity wireless communications, which may permit less stringent latency requirements (e.g., higher latency than URLLC) and less reliable radio performance as compared to URLLC. Performance requirements for mMTC may be lower than for eMBB use cases. Some use case applications involving mobile devices or mobile user equipment such as smart phones, wireless tablets, smart watches, and the like, may impose, on a given RAN resource, loads, or demands, that vary. A RAN node may activate a network energy saving mode to reduce power consumption.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In an example embodiment, a method may comprise facilitating, by a radio network node comprising at least one processor, transmitting, to at least one user equipment, at least one beam reporting configuration message comprising at least one measurement beam parameter value indication indicative of at least one measurement beam parameter value corresponding to at least one measurement beam. The method may further comprise facilitating, by the radio network node, broadcasting the at least one measurement beam according to the at least one measurement beam parameter value and facilitating, by the radio network node, receiving, from the at least one user equipment, at least one beam measurement report comprising at least one beam parameter measurement value indication indicative of at least one beam parameter measurement value determined by the at least one user equipment. Based on the at least one beam parameter measurement value, the method may further comprise determining, by the radio network node, at least one delivery beam to facilitate delivery of traffic with respect to the at least one user equipment to result in at least one determined delivery beam. The method may further comprise facilitating, by the radio network node, the delivery of the traffic, via the at least one determined delivery beam, with respect to the at least one user equipment.

In an example embodiment, a set of measurement beams may comprise the at least one measurement beam. A set of delivery beams may comprise the at least one delivery beam. The set of measurement beams may correspond to a measurement beam gain and a measurement beam geographic coverage area. The set of delivery beams may correspond to a delivery beam gain and a delivery beam geographic coverage area. The measurement beam gain may be smaller than the delivery beam gain. The measurement beam geographic coverage area may be larger than the delivery beam geographic coverage area.

In an example embodiment, the determining of the at least one determined delivery beam may comprise inputting the at least one beam parameter measurement value to a delivery beam management learning model to result in a trained delivery beam management learning model. Based on at least one output of the delivery beam management learning model, determining at least one delivery beam parameter value corresponding to the at least one determined delivery beam. In an embodiment, the trained delivery beam management learning model may be specific to the at least one user equipment.

In an embodiment, the at least one determined delivery beam may be a first determined delivery beam. The at least one beam measurement report may be a first beam measurement report. The at least one beam parameter measurement value indication may be at least one first beam parameter measurement value indication. The at least one first beam parameter measurement value indication may be indicative of at least one first beam parameter measurement value determined by the at least one user equipment. The delivery of the traffic may be the delivery of first traffic. The method may further comprise facilitating, by the radio network node, receiving, from the at least one user equipment, a second beam measurement report comprising at least one second beam parameter measurement value indication indicative of at least one second beam parameter measurement value determined by the at least one user equipment with respect to the first determined delivery beam. Based on the at least one second beam parameter measurement value, the method may further comprise determining, by the radio network node, at least one second delivery beam to facilitate delivery of second traffic with respect to the at least one user equipment to result in a second determined delivery beam, wherein the second determined delivery beam is different than the first determined delivery beam. The method may further comprise facilitating, by the radio network node, the delivery of the second traffic, via the second determined delivery beam, with respect to the at least one user equipment.

In an example embodiment, the at least one beam parameter measurement value may comprise at least one measurement beam parameter measurement value. The at least one beam reporting configuration message may further comprise at least one beam reporting number indication indicative that the at least one user equipment is to report, via the at least one beam measurement report, a best beam parameter measurement value corresponding to a best beam, of the at least one measurement beam, that corresponds to at least one of the at least one measurement beam parameter measurement value being better, with respect to at least one measurement beam parameter, than at least one of the at least one measurement beam parameter measurement value that corresponds to at least one other beam of the at least one measurement beam. The at least one measurement beam parameter may be at least one of: a beam signal strength, or a ratio of the beam signal strength with respect to noise or interference.

In an example embodiment, each of the at least one measurement beam may be ranked, by the at least one user equipment, according to at least one beam parameter to result in at least one ranked measurement beam. The at least one beam reporting configuration message may further comprise at least one beam reporting number indication indicative of a reporting number according to which the at least one user equipment is to report, via the at least one beam measurement report, at least one beam measurement value associated with each of a number, corresponding to the reporting number, of the at least one ranked measurement beam having a highest at least one rank with respect to the at least one beam parameter.

In an example embodiment, the at least one beam reporting configuration message may further comprise information representative of at least one beam measurement difference reporting request. The at least one beam measurement report may comprise at least one beam measurement difference indication. The at least one beam parameter measurement value may comprise at least one measurement beam parameter measurement value. The at least one beam measurement difference indication may comprise at least one of: a first difference indication indicative of a first difference between at least one delivery beam parameter measurement value, corresponding to the at least one determined delivery beam and determined by the at least one user equipment, and the at least one measurement beam parameter measurement value; or a second difference indication indicative of a standard deviation corresponding to a delivery beam mean determined with respect to the at least one determined delivery beam parameter measurement value and a measurement beam mean determined with respect to the at least one measurement beam parameter measurement value.

In an example embodiment, the at least one measurement beam may be different than the at least one delivery beam. The at least one measurement beam may be a non-idle-mode beam and the at least one delivery beam may be a non-idle-mode beam.

In an example embodiment, the at least one user equipment is excluded from determination of a beam parameter measurement value with respect to the at least one determined delivery beam.

In another example embodiment, a radio network node may comprise at least one processor configured to process executable instructions that, when executed by the at least one processor, facilitate performance of operations that may comprise transmitting, to at least one user equipment, at least one beam reporting configuration message comprising at least one beam parameter indication indicative of at least one measurement beam parameter value corresponding to at least one measurement beam, broadcasting the at least one measurement beam according to the at least one measurement beam parameter value, and receiving, from the at least one user equipment, at least one beam measurement report comprising at least one beam parameter measurement value indication indicative of at least one beam parameter measurement value that corresponds to the at least one measurement beam and that is determined by the at least one user equipment. Based on the at least one beam parameter measurement value, the operations may further comprise determining at least one delivery beam to facilitate communication of traffic with respect to the at least one user equipment to result in at least one determined delivery beam. The operations may further comprise transmitting, to the at least one user equipment, at least one beam switching information message indicative of at least one delivery beam parameter value corresponding to the at least one determined delivery beam, and communicating, via the at least one determined delivery beam, the traffic with respect to the at least one user equipment.

In an example embodiment, the determining of the at least one determined delivery beam may comprise providing the at least one beam parameter measurement value as an input to a delivery beam management learning model to result in a trained delivery beam management learning model, wherein the at least one delivery beam parameter value is determined based on at least one output of the delivery beam management learning model.

In an example embodiment, the at least one determined delivery beam may be a first determined delivery beam. The at least one beam measurement report may be a first beam measurement report. The at least one beam parameter measurement value indication may be at least one first beam parameter measurement value indication indicative of at least one first beam parameter measurement value determined by the at least one user equipment. The at least one beam switching information message may be at least one first beam switching information message. The communication of the traffic may be the communication of first traffic. The operations may further comprise receiving, from the at least one user equipment, a second beam measurement report comprising at least one second beam parameter measurement value indication indicative of at least one second beam parameter measurement value determined, by the at least one user equipment, with respect to the first determined delivery beam. Based on the at least one second beam parameter measurement value, the operations may further comprise determining at least one second delivery beam to facilitate communication of second traffic with respect to the at least one user equipment to result in a second determined delivery beam. The second determined delivery beam may be different than the first determined delivery beam. The operations may further comprise transmitting, to the at least one user equipment, at least one second beam switching information message indicative of at least one second delivery beam parameter value corresponding to the at least one second determined delivery beam, and communicating, via the second determined delivery beam, the second traffic with respect to the at least one user equipment. At least one of the at least one first beam switching information message or the at least one second beam switching information message may comprise at least one of at least one spatial angular direction indication or at least one beam gain indication.

In an example embodiment, the at least one first beam switching information message and the at least one second beam switching information message may comprise first information corresponding to the first determined delivery beam and second information corresponding the second determined delivery beam, respectively, with respect to which the at least one user equipment may not have determined at least one beam parameter measurement value.

In another example embodiment, a non-transitory machine-readable medium may comprise executable instructions that, when executed by at least one processor of radio network equipment, may facilitate performance of operations that may comprise transmitting, to a connected-mode user equipment, a beam reporting configuration message comprising at least one beam parameter indication indicative of at least one measurement beam parameter value corresponding to at least one measurement beam, broadcasting at least one reference signal via the at least one measurement beam according to the at least one measurement beam parameter value, and receiving, from the connected-mode user equipment, at least one beam measurement report comprising at least one beam parameter measurement value indication indicative of at least one beam parameter measurement value, corresponding to the at least one measurement beam, that is determined by the connected-mode user equipment. Based on the at least one beam parameter measurement value, the operations may further comprise determining a delivery beam to facilitate delivery of traffic with respect to the connected-mode user equipment to result in a determined delivery beam. The operations may further comprise transmitting, to the connected-mode user equipment, at least one beam switching information message indicative of at least one delivery beam parameter value corresponding to the determined delivery beam, and delivering the traffic, via the determined delivery beam, with respect to the connected-mode user equipment. In an example embodiment, the determining of the determined delivery beam may comprise inputting the at least one beam parameter measurement value to a delivery beam management learning model to result in a trained delivery beam management learning model, and based on at least one output of the delivery beam management learning model, obtaining at least one delivery beam parameter value corresponding to the determined delivery beam.

In yet another example embodiment, a method may comprise facilitating, by a radio network node comprising at least one processor, broadcasting at least one beam reporting configuration message comprising at least one measurement beam parameter indication indicative of at least one measurement beam parameter value corresponding to at least one measurement beam and facilitating, by the radio network node, broadcasting the at least one measurement beam according to the at least one measurement beam parameter value. Responsive to the broadcasting of the at least one measurement beam, the method may further comprise facilitating, by the radio network node, receiving, from at least one user equipment, at least one beam measurement connection establishment request. Responsive to the at least one beam measurement connection establishment request, the method may further comprise facilitating, by the radio network node, establishing, with the at least one user equipment, at least one beam measurement connection to result in at least one established beam measurement connection. The method may further comprise facilitating, by the radio network node, receiving, from the at least one user equipment via the at least one established beam measurement connection, at least one beam measurement report comprising at least one beam parameter measurement value indication indicative of at least one beam parameter measurement value, determined by the at least one user equipment, that corresponds to the at least one measurement beam. Based on the at least one beam parameter measurement value, the method may further comprise determining, by the radio network node, at least one delivery beam to facilitate delivery of traffic with respect to the at least one user equipment to result in at least one determined delivery beam. The method may further comprise terminating, by the radio network node, the at least one established beam measurement connection.

In an example embodiment, the at least one beam measurement connection establishment request may comprise at least one request for a reduced-capability connection. The at least one established beam measurement connection may be at least one reduced capability connection capable of the facilitating of the receiving of the at least one beam measurement report. In an embodiment, the at least one reduced-capability connection may not be capable of facilitating transmitting of downlink traffic to the at least one user equipment.

In an example embodiment, the method may further comprise facilitating, by the radio network node, receiving, from the at least one user equipment, at least one traffic delivery connection establishment request. Responsive to the at least one traffic delivery connection establishment request, the method may further comprise facilitating, by the radio network node, establishing a full-capability connection with the at least one user equipment according to the at least one determined delivery beam. The method my further comprise facilitating, by the radio network node, the delivery of the traffic, via the at least one determined delivery beam, with respect to the at least one user equipment.

In an example embodiment, the at least one traffic delivery connection establishment request may be a first traffic delivery connection establishment request. The full-capability connection may be a first full-capability connection. The at least one user equipment may be a first user equipment. The delivery of the traffic may be the delivery of first traffic. The method may further comprise facilitating, by the radio network node, receiving, from a second user equipment of the at least one user equipment, a second traffic delivery connection establishment request. Responsive to the second traffic delivery connection establishment request, the method may further comprise facilitating, by the radio network node, establishing a second full-capability connection with the second user equipment according to the at least one determined delivery beam. The method may further comprise facilitating, by the radio network node, delivery, via the at least one determined delivery beam, of second traffic with respect to the second user equipment.

In an example embodiment, the first user equipment and the second user equipment may be geographically located within a geographic range of one another corresponding to a beam width associated with the at least one determined delivery beam.

In an example embodiment, the at least one beam reporting configuration message may be broadcast by at least one synchronization signal block beam corresponding to at least one synchronization signal block beam direction. The at least one measurement beam may correspond to at least one measurement beam direction that is associated with the at least one synchronization signal block beam direction. The at least one beam measurement report may further comprise at least one synchronization signal block beam indication indicative of the at least one synchronization signal block beam that corresponds to the at least one measurement beam. The determining of the at least one determined delivery beam may be based on the at least one synchronization signal block beam indication.

In an example embodiment, the at least one beam reporting configuration message may be broadcast via at least one synchronization signal block beam. The at least one beam reporting configuration message may comprise at least one beam measurement mode indication indicative of a dynamic reporting mode according to which the at least one user equipment is to avoid transmitting the at least one beam measurement connection establishment request unless the at least one user equipment determines that the at least one beam parameter measurement value, which corresponds to the at least one measurement beam, satisfies a measurement beam reporting criterion. The measurement beam reporting criterion may comprises at least one of: a first criterion based on a difference, or a second criterion based on a standard deviation, with respect to at least one of which the at least one user equipment is to analyze a first measurement value corresponding to the at least one measurement beam and a second measurement value corresponding to the at least one synchronization signal block beam.

The measurement beam reporting criterion may comprise comprises at least one of: a first criterion based on a difference, or a second criterion based on a standard deviation, with respect to at least one of which the at least one user equipment is to analyze a first measurement value corresponding to the corresponding to the at least one measurement beam and a second measurement value corresponding to a synchronization signal block beam, which is determined by the at least one user equipment to be a best synchronization signal block beam based on a synchronization signal block signal strength parameter value corresponding to the best synchronization signal block beam.

In an example embodiment, the at least one beam measurement report may be further indicative of the at least one measurement beam ranked in descending order according to the at least one beam parameter measurement value.

In an example embodiment, the at least one measurement beam parameter indication may comprise at least one of a timing resource indication or at least one frequency resource indication indicative, respectively, of at least one timing resource or at least one frequency resource corresponding to the at least one measurement beam.

In another example embodiment, a radio network node may comprise at least one processor configured to process executable instructions that, when executed by the at least one processor may facilitate performance of operations that may comprise broadcasting at least one beam reporting configuration message comprising at least one beam parameter indication indicative of at least one measurement beam parameter value corresponding to at least one measurement beam, broadcasting the at least one measurement beam according to the at least one measurement beam parameter value, and receiving, from at least one idle-mode user equipment, at least one beam measurement report comprising at least one beam parameter measurement value indication indicative of at least one beam parameter measurement value that corresponds to the at least one measurement beam and that is determined by the at least one idle-mode user equipment. Based on the at least one beam parameter measurement value, the operations may further comprise determining at least one delivery beam to facilitate delivery of traffic with respect to at least one of the at least one idle-mode user equipment to result in at least one determined delivery beam.

In an example embodiment, the at least one idle-mode user equipment may comprise a first user equipment. The operations may further comprise establishing a traffic delivery connection with a second user equipment to result in an established traffic delivery connection, and delivering, via the at least one determined delivery beam and via the established traffic delivery connection, traffic with respect to the second user equipment.

In an example embodiment, the operations may further comprise determining that the first user equipment is geographically located within a configured geographic range criterion of the second user equipment, wherein the delivering the traffic via the at least one determined delivery beam may be based on the second user equipment being located within the configured geographic range criterion of the first user equipment. The determining that the first user equipment may geographically located within a configured geographic range criterion of the second user equipment may comprise determining that the first user equipment and the second user equipment both indicated, to the radio network node, a same synchronization signal block signal beam as a best synchronization signal block signal beam.

In an example embodiment, the at least one idle-mode user equipment does not comprise the second user equipment.

Another example embodiment may comprise a non-transitory machine-readable medium that may comprise executable instructions that, when executed by at least one processor of radio network equipment may facilitate performance of operations that may comprise broadcasting at least one beam reporting configuration message comprising at least one beam parameter indication indicative of at least one measurement beam parameter value corresponding to at least one measurement beam, broadcasting the at least one measurement beam according to the at least one measurement beam parameter value, and receiving, from at least one idle-mode user equipment, at least one beam measurement report comprising at least one beam parameter measurement value indication indicative of at least one beam parameter measurement value that corresponds to the at least one measurement beam and that is determined by the at least one idle-mode user equipment. Based on the at least one beam parameter measurement value, the operations may further comprise determining at least one delivery beam to facilitate delivery of traffic with respect to at least one of the at least one idle-mode user equipment to result in at least one determined delivery beam.

In an example embodiment, the at least one beam measurement report may comprise at least one measurement beam indication, indicative of the at least one measurement beam, ranked in a descending order according to the at least one beam parameter measurement value to result in a measurement beam ranking order. The determining of the at least one delivery beam may be based on at least one of the at least one measurement beam indication or the measurement beam ranking order. The at least one measurement beam indication or the measurement beam ranking order may be input to at least one machine learning model. The determining of the at least one delivery beam may be facilitated by the at least one machine learning model.

In yet another example embodiment, a method may comprise receiving, by at least one user equipment comprising at least one processor from a radio network node, at least one beam reporting configuration message comprising at least one measurement beam parameter indication indicative of at least one measurement beam parameter value corresponding to at least one measurement beam, receiving, by the at least one user equipment via the at least one measurement beam according to the at least one measurement beam parameter value, at least one measurement signal to result in at least one received measurement signal, determining, by the at least one user equipment, at least one measurement signal strength parameter value corresponding to the at least one received measurement signal, and transmitting, by the at least one user equipment to the radio network node, at least one beam measurement connection establishment request. Based on the transmitting of the at least one beam measurement connection establishment request, the method may further comprise establishing, by the at least one user equipment with the radio network node, at least one beam measurement reporting connection to result in at least one established beam measurement reporting connection. The method may further comprise transmitting, by the at least one user equipment to the radio network node via the at least one established beam measurement reporting connection, at least one beam measurement report comprising the at least one measurement signal strength parameter value.

In an example embodiment, the at least one beam measurement connection establishment request may comprise at least one request for a reduced-capability connection. The at least one established beam measurement reporting connection may be at least one reduced-capability connection capable of facilitating the receiving the at least one beam measurement report. The at least one reduced-capability connection may be a connection that is not capable of facilitating transmitting downlink traffic to the at least one user equipment.

In an example embodiment, the method may further comprise transmitting, by the at least one user equipment, at least one traffic delivery connection establishment request. Responsive to the at least one traffic delivery connection establishment request, the method may further comprise establishing, by the at least one user equipment, at least one full-capability connection with the at least one user equipment corresponding to at least one determined delivery beam determined by the radio network node based on the at least one measurement signal strength parameter value. The method may further comprise receiving, by the at least one user equipment from the radio network node via the at least one determined delivery beam and via the at least one full-capability connection, traffic.

In an example embodiment, the at least one user equipment may comprise a first user equipment. The method may further comprise transmitting, by a second user equipment of the at least one user equipment, a traffic delivery connection establishment request. Based on the transmitting of the traffic delivery connection establishment request, the method may further comprise establishing, by the second user equipment, a full-capability connection with the radio network node according to at least one determined delivery beam determined by the radio network node based on the at least one measurement signal strength parameter value. The method may further comprise receiving, by the second user equipment from the radio network node via the at least one determined delivery beam and via the full-capability connection, traffic.

In an example embodiment, the first user equipment and the second user equipment may be geographically located within a geographic range of one another corresponding to a beam width associated with the at least one determined delivery beam.

In an example embodiment, the at least one beam reporting configuration message may be received via a synchronization signal block beam corresponding to a synchronization signal block beam direction. The at least one measurement beam may correspond to at least one measurement beam direction that is associated with the synchronization signal block beam direction.

In an example embodiment, the at least one beam measurement report may further comprise at least one synchronization signal block beam indication indicative of the synchronization signal block beam that corresponds to the at least one measurement beam. The at least one determined delivery beam may be determined by the radio network node based on the at least one synchronization signal block beam indication.

In an example embodiment, the at least one beam reporting configuration message may comprise at least one beam measurement mode indication indicative of a dynamic reporting mode according to which the at least one user equipment is to avoid the transmitting the at least one beam measurement connection establishment request unless the at least one user equipment determines that the at least one measurement signal strength parameter value, which corresponds to the at least one measurement beam, satisfies a measurement beam reporting criterion.

The method may further comprise measuring, by the at least one user equipment, at least one synchronization signal block signal strength parameter value corresponding to at least one synchronization signal block signal corresponding to at least one synchronization signal block beam associated with the radio network node to result in at least one measured synchronization signal block signal strength parameter value. Based on the at least one measured synchronization signal block signal strength parameter value, the method may further comprise determining, by the at least one user equipment, a synchronization signal block beam of the at least one synchronization signal block beam that corresponds to a best measured synchronization signal block signal strength parameter value of the at least one measured synchronization signal block signal strength parameter value to result in a determined best synchronization signal block beam. The method may further comprise analyzing, by the at least one user equipment, the at least one measurement signal strength parameter value with respect to the best measured synchronization signal block signal strength parameter value to result in a signal strength parameter difference value, and analyzing, by the at least one user equipment, the signal strength parameter difference value with respect to a configured measurement beam reporting criterion to result in an analyzed signal strength parameter difference value. The transmitting of the at least one beam measurement connection establishment request may be based on the analyzed signal strength parameter difference value being determined, by the at least one user equipment, to satisfy the configured measurement beam reporting criterion. The measurement beam reporting criterion may comprise at least one of: a first criterion based on a difference, or a second criterion based on a standard deviation, with respect to at least one of which the at least one user equipment is to analyze a first measurement value corresponding to the at least one measurement signal strength parameter value corresponding to the at least one measurement beam and a second measurement value corresponding to the determined best synchronization signal block beam.

In an example embodiment, the method may further comprise ranking, by the at least one user equipment, the at least one measurement beam in descending order according to the at least one measurement signal signal strength parameter value to result in a measurement beam ranking order, wherein the at least one beam measurement report is further indicative of the measurement beam ranking order.

In an example embodiment, the at least one measurement signal signal strength parameter value may comprise at least one of: at least one signal strength value corresponding to the at least one measurement beam or at least one ratio of the at least one signal strength value with respect to at least one of at least one noise value or at least one interference value determined by the at least one user equipment.

In an example embodiment, the at least one beam reporting configuration message may be further indicative of at least one of a timing resource indication or at least one frequency resource indication indicative, respectively, of at least one timing resource or at least one frequency resource corresponding to the at least one measurement beam.

In an example embodiment, the at least one measurement beam parameter value may comprise at least one of: at least one quantity of the at least one measurement beam, at least one angular direction indication indicative of at least one direction corresponding to the at least one measurement beam, or at least one gain indication indicative of at least one beam gain corresponding to the at least one measurement beam.

In an example embodiment, the at least one beam reporting configuration message may comprise at least one beam measurement mode indication indicative of a static reporting mode according to which the transmitting of the at least one beam measurement connection establishment request is to be responsive to the receiving of the at least one beam reporting configuration message.

In another example embodiment, a user equipment may comprise at least one processor configured to process executable instructions that, when executed by the at least one processor, may facilitate performance of operations that may comprise receiving, via at least one measurement beam corresponding to a radio network node, at least one measurement signal to result in at least one received measurement signal, determining at least one measurement signal signal strength parameter value corresponding to the at least one received measurement signal to result in at least one determined measurement signal signal strength parameter value, and transmitting, to the radio network node, at least one beam measurement connection establishment request. Based on the transmitting of the at least one beam measurement connection establishment request, the operations may further comprise establishing, by with the radio network node, at least one beam measurement reporting connection to result in at least one established beam measurement reporting connection. The operations may further comprise transmitting, to the radio network node via the at least one established beam measurement reporting connection, at least one beam measurement report comprising the at least one determined measurement signal signal strength parameter value.

In an example embodiment, the operations may further comprise measuring at least one synchronization signal block signal strength parameter value corresponding to at least one synchronization signal block signal corresponding to at least one synchronization signal block beam associated with the radio network node to result in at least one measured synchronization signal block signal strength parameter value. Based on the at least one measured synchronization signal block signal strength parameter value, the operations may further comprise determining a synchronization signal block beam of the at least one synchronization signal block beam that corresponds to a best measured synchronization signal block signal strength parameter value of the at least one measured synchronization signal block signal strength parameter value to result in a determined best synchronization signal block beam. The operations may further comprise analyzing the at least one determined measurement signal signal strength parameter value with respect to the best measured synchronization signal block signal strength parameter value to result in a signal strength parameter difference value and analyzing the signal strength parameter difference value with respect to a configured measurement beam reporting criterion to result in an analyzed signal strength parameter difference value. The transmitting of the at least one beam measurement connection establishment request may be based on the analyzed signal strength parameter difference value being determined, by the user equipment, to satisfy the configured measurement beam reporting criterion.

In an example embodiment, the operations may further comprise ranking, by the user equipment, the at least one measurement beam according to the at least one determined measurement signal signal strength parameter value to result in a measurement beam ranking order. The at least one beam measurement report is further indicative of the measurement beam ranking order.

In another example embodiment, a non-transitory machine-readable medium may comprise executable instructions that, when executed by at least one processor of a user equipment, may facilitate performance of operations that may comprise receiving, from radio network equipment, a beam reporting configuration message indicative of at least one measurement beam, receiving, via the at least one measurement beam, at least one measurement signal to result in at least one received measurement signal, determining at least one measurement signal signal strength parameter value corresponding to the at least one received measurement signal to result in at least one determined measurement signal signal strength parameter value, and transmitting, to the radio network equipment, at least one beam measurement connection establishment request. Based on the transmitting of the at least one beam measurement connection establishment request, the operations may further comprise establishing, with the radio network equipment, at least one beam measurement reporting connection to result in at least one established beam measurement reporting connection. The operations may further comprise transmitting, to the radio network equipment via the at least one established beam measurement reporting connection, at least one beam measurement report comprising the at least one determined measurement signal signal strength parameter value. The operations may comprise terminating the at least one established beam measurement reporting connection.

In an example embodiment, the operations may further comprise transmitting, to the radio network equipment, at least one traffic delivery connection establishment request. Responsive to the at least one traffic delivery connection establishment request, the operations may further comprise establishing, with the radio network equipment, a full-capability connection according to at least one determined delivery beam determined by the radio network equipment based on the at least one determined measurement signal signal strength parameter value. The operations may further comprise communicating, with the radio network equipment, traffic using the at least one determined delivery beam.

### BRIEF DESCRIPTION OF THE DRAWINGS

FIG. 1 illustrates wireless communication system environment.

FIG. 2 illustrates an example environment with a radio network node training a learning model and delivering traffic with respect a user equipment based on signal measurement values reported by a user equipment.

FIG. 3 illustrates example beam reporting configuration information usable by connected-mode user equipment.

FIG. 4 illustrates an example environment with a radio network node providing multiple measurement beams, associated with a synchronization signal block signal beam, to a user equipment.

FIG. 5 illustrates an example beam measurement report comprising beam parameter measurement value information determined by a connected-mode user equipment.

FIG. 6 illustrates an example environment with a radio network node transmitting example beam switching information to a user equipment.

FIG. 7 illustrates example beam measurement difference information.

FIG. 8 illustrates an example a timing diagram of an example embodiment of a radio network node determining a delivery beam based on beam parameter measurements made by a user equipment connected with the node.

FIG. 9 illustrates an example environment with a radio network node training a learning model based on signal measurement values reported by idle-mode user equipment.

FIG. 10 illustrates an example environment with a user equipment measuring multiple measurement beams corresponding to a synchronization signal block beam.

FIG. 11 illustrates an example beam measurement report comprising beam parameter measurement value information determined by an idle-mode user equipment.

FIG. 12 illustrates a timing diagram of an example embodiment of a radio network node training a learning model based on signal measurement values reported by idle-mode user equipment.

FIG. 13 illustrates a timeline of an idle-mode user equipment measuring at least one measurement beam and reporting at least one measurement value corresponding thereto to a radio network node.

FIG. 14 illustrates an example timing diagram of an example user equipment measuring at least one measurement beam and reporting at least one measurement value corresponding thereto to a radio network node.

FIG. 15 illustrates a flow diagram of an example embodiment method of training a beam determining learning model based on information measured by user equipment and delivering traffic via a delivery beam that is predicted by the trained learning model.

FIG. 16 illustrates a block diagram of an example method embodiment.

FIG. 17 illustrates a block diagram of an example radio network node embodiment.

FIG. 18 illustrates a block diagram of an example non-transitory machine-readable medium embodiment.

FIG. 19 illustrates a block diagram of an example method embodiment.

FIG. 20 illustrates a block diagram of an example radio network node embodiment.

FIG. 21 illustrates a block diagram of an example non-transitory machine-readable medium embodiment.

FIG. 22 illustrates a block diagram of an example method embodiment.

FIG. 23 illustrates a block diagram of an example user equipment embodiment.

FIG. 24 illustrates a block diagram of an example non-transitory machine-readable medium embodiment.

FIG. 25 illustrates an example computer environment.

FIG. 26 illustrates a block diagram of an example wireless user equipment.

### DETAILED DESCRIPTION

As a preliminary matter, it will be readily understood by those persons skilled in the art that the present embodiments are susceptible of broad utility and application. Many methods, embodiments, and adaptations of the present application other than those herein described as well as many variations, modifications and equivalent arrangements, will be apparent from or reasonably suggested by the substance or scope of the various embodiments of the present application.

Accordingly, while the present application has been described herein in detail in relation to various embodiments, it is to be understood that this disclosure is illustrative of one or more concepts expressed by the various example embodiments and is made merely for the purposes of providing a full and enabling disclosure. The following disclosure is not intended nor is to be construed to limit the present application or otherwise exclude any such other embodiments, adaptations, variations, modifications and equivalent arrangements, the present embodiments described herein being limited only by the claims appended hereto and the equivalents thereof.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. In yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Artificial intelligence and machine learning (“AI/ML”) may facilitate optimizing performance as compared to rules-based techniques in myriad fields. With respect to 5G NR, and future wireless communication generations, AI/ML may facilitate operations including, for example, channel state information acquisition/prediction, radio positioning, and beam management. An AI/ML model may be trained at one entity, for example at a gNB/RAN node or at a user equipment. A trained model trained at one entity may be transferred toward the other via radio interface link(s). For example, a learning model may be trained at a RAN node and transferred, ready for execution, toward various AI-capable user equipment devices. Thus, AI/ML processing-heavy model training is separated from the entity actively running such model to facilitate radio functionality. For example, a learning model trained at a RAN node may be transferred, or delivered, as a ready-trained model, toward user equipment devices via a downlink radio interface link to facilitate executing AI/ML driven beam failure detection and recovery operations. Sizes of AI learning models used to facilitate radio functionality may range from small to large depending on model complexity and purpose. Therefore, it is desirable to efficiently deliver AI/ML ready-trained model via radio interface link(s) for AI/ML model transfer-dependent AI use cases. A ready-trained inference learning model can be transmitted via radio interface link(s) either as semi-static control channel traffic or as dynamically-scheduled data traffic. However, each transmission mode may impose, cause, or experience, radio channel resource limitations due to the nature and potential sizes of AI/ML models.

AI-powered beam management may reduce radio signaling overhead, in both uplink and downlink directions, used to facilitate determining a best serving beam for a user equipment device. Without AI adoption, a RAN node transmits multiple downlink reference signals via all available downlink traffic delivery beams, which may result in hundreds of beams. Traffic delivery beams may be referred to as Set A beams. The RAN node may transmit the reference signals via the multiple downlink beams to facilitate a user equipment determining and reporting to the RAN node which of the beams delivers the best coverage from the perspective of the UE. Such transmission of reference signals via all downlink beams results in significant downlink and uplink signaling overhead. However, with AI adoption to facilitate beam management and determination, reference signals may be transmitted via a much smaller set of Set B beams by a RAN node to facilitate beam signal measurement and reporting by a UE. A set of Set B beams comprises a number of beams that is much smaller than a number of beams of a typical set of Set A beams, which typically results in a Set B beam having a wider geographic coverage footprint and lower gain as compared to a set A beam. A RAN node may receive signal measurement values corresponding to Set B beams and input the measurement values into a beam management/delivery beam determining learning model, which may determine a refined Set A beam (e.g., refined as compared to a wider, lower gain set B beam) for use in exchanging and delivering data to or from a user equipment. Thus, for example, a refined beam selected from a set of 1024 Set A beams may be adopted by a user equipment while the user equipment may continue use of a set of 64 Set B beams corresponding to a RAN node to receive reference signals from the RAN node and to receive device reports from the RAN node.

However, conventional use of AI-powered beam management models operates based on an assumption that a beam management model is well-trained and will remain well-trained while being used. Such an assumption may impose a limitation on the efficacy of an AI-driven beam management model due to wide dynamics experienced by radio interface link(s) that may severely impact performance of the model. For example, interference, UE mobility, coverage level/signal strength estimation accuracy, traffic loading, may lead to use of many predefined AI models that have been trained to anticipate various possible combinations of radio channel dynamics or may lead to adoption of an AI model for beam management within an environment with respect to which the model has been never trained, thus resulting in a problem of AI model performance degradation.

Example embodiments described herein may facilitate solving problems existing with respect to conventional techniques. According to embodiments disclosed herein, connected-mode user equipment operating in a connected mode with respect to a RAN node (e.g., a user equipment with ongoing active communication session(s) with the RAN) may measure and report, to a RAN node, beam parameter values to be used by the RAN node to train a delivery beam determining learning model that may be used to facilitate downlink beam management. Example embodiments disclosed herein may disregard a conventional AI learning model implementation and may facilitate dynamic and real-time AI model refinement based on configured continuous or on-demand online learning model training such that a trained learning model is trained based on real-time radio conditions. Example embodiments disclosed herein may facilitate AI-model-based beam management that adopts a refined beam of a large set of refined delivery beams (which may be referred to herein as Set A beams) based on measuring of signal parameters, by connected-mode user equipment, of measurement beams, which may be referred to herein as Set B beams and which may comprise fewer beams than set A beams and which each may have a wider per-beam coverage pattern than Set A delivery beams.

Although user equipment that are operating in a connected mode may measure measurement beam signal parameters (e.g., signal strength-parameter values corresponding to Set-B beams) and thus facilitate a RAN refining, by training a learning model based on beam parameter values measured by the user equipment, a delivery beam according to which traffic may be delivered with respect to the connected mode device, since the measurements are determined by user equipment and transmitted thereby to the RAN while operating in a connected mode while connected to the RAN, session performance corresponding to the connection between the UE and RAN may be degraded until the measuring and transmitting of beam parameter values has completed, while the AI model refinement at the RAN is being performed, or until prediction of a delivery beam has completed. However, performing measurement, training, and determining of delivery beam(s) during connected-mode operation may minimize modification of conventional user equipment operations.

In other example embodiments, a radio network node may facilitate avoiding idle-mode AI model training procedures for beam management during connected-mode, wherein AI model training may be performed by user equipment operating in an idle mode. Most user equipment operate in an idle mode/state most of the time. Thus, utilizing such extended idle-mode time periods to perform AI model training and refinement may result in very little degradation with respect to communication session traffic delivery. According to example embodiments disclosed herein, a RAN node may activate Set B AI training beams, which may be referred to as measurement beams, with respect to idle-mode user equipment devices and may receive signal measurements, or training samples, from idle-mode user equipment. According to embodiments disclosed herein, AI beam training/measurement samples received from a user equipment may be tied not to a certain user equipment but may be considered by the RAN node as having been received from a generic user equipment device experiencing determined radio conditions and being located in a determined location. Such signal measurement sample value may be useful in refining AI model performance for beam predictions of connected mode user equipment, other than a user equipment that measures and transmits to a RAN node measurement beam signal sample value, that share similar locations and radio conditions of an idle mode user equipment that reported the measurement beam signal samples, thus avoiding disruption of an active communication session time being conducted by a connected mode user equipment. In example embodiments, dynamic idle-mode AI-model training procedures may facilitate a RAN node in controlling which idle-mode user equipment devices participate during an AI training instant or occasion, thus potentially avoiding measurement beam signal sample values received from a large number of idle-mode user equipment devices that are close to the RAN node ‘overpowering’, or biasing, the training of a beam management model.

In example embodiments, at least one user equipment may facilitate idle-mode AI model training procedures for use in beam management for user equipment operating in a connected-mode. By conducting AI model training by user equipment operating in an idle-mode while conducing AI inference beam determining for user equipment operating in a connected model, use of precious and limited connected-mode time and frequency resources to facilitate AI beam management model training is minimized. Due to the different nature of idle mode connectivity compared to connected mode connectivity, wherein the volume of user equipment operating in idle mode is typically much larger than user equipment operating in a connected mode, embodiments disclosed herein may facilitate use of user-equipment-centric techniques that may avoid a large number of idle-mode devices simultaneously reporting AI beam training measurements and that may avoid reporting by idle-mode user equipment that would otherwise potentially report non-important measurement results (e.g., signal measurement value reported by user equipment that are close to a RAN node may be unimportant and may even skew training of a learning model). During the idle mode AI beam training operation, example embodiments disclosed herein may facilitate idle mode user equipment devices autonomously determining the effectiveness measurement beam signal measurement values, (e.g., a UE may determine whether a signal parameter value corresponding to a measurement beam that is measured by the UE would provide useful, effective training information that would likely improve AI model confidence). Based on such dynamic, autonomous determination by an idle-mode user equipment, an idle-mode user equipment may determine not to report, to a RAN node, measurement beam signal parameter measurement values determined by the UE.

According to conventional techniques, a RAN node selects a serving downlink delivery beam for use in delivering traffic with respect to a connected mode user equipment based on a beam measurement report, received from the user equipment, that is indicative of a beam signal measurement value determined by the user equipment with respect to the determined delivery beam. The RAN node uses the beam signal measurement value to determine that the determined delivery beam delivers the best received coverage level at the devices.

Unlike conventional techniques, according to novel example embodiments disclosed herein, a RAN node may adopt as a delivery beam, to facilitate delivery of traffic with respect to a user equipment, a beam from a set of Set A beams that has never been measured nor reported by the user equipment to the RAN node, based on a prediction facilitated by a learning model, which may be trained or refined by input training signal sample value received from user equipment.

According to conventional techniques, different AI models are trained and generated to accommodate different radio channel conditions that may be experienced by a user equipment and one of the different models may be used to determine a delivery beam for use with respect to a specific user equipment. Despite advantages provided by use of conventional techniques as compared to techniques that do not use trained models, the conventional techniques require user equipment devices to be connected and to execute AI training as part of an ongoing communication session, which degrades overall radio link performance until training is finished.

Instead, according to novel example embodiments disclosed herein, an AI beam training instant, or occasion, may be tied to a generic device at a determined geographic location and radio network location instead of being tied to a specific device. Thus, according to example embodiments disclosed herein, a refined AI model, trained at a RAN node, may be used to determine a refined delivery beam for delivery of traffic to other user equipment sharing similar characteristics with the user equipment that measured and reported beam model training sample values.

According to example embodiments disclosed herein, an idle-mode user equipment may request from a RAN node establishment of a temporary, purpose-specific, uplink-only, reduced capability connection to facilitate reporting of measurement beam signal sample values to the RAN node.

According to example embodiments disclosed herein, a user equipment operating in an idle-mode may perform on-demand or periodic AI beam training measurement of measurement beam signal values and may dynamically determine whether to report to the RAN node the measured values.

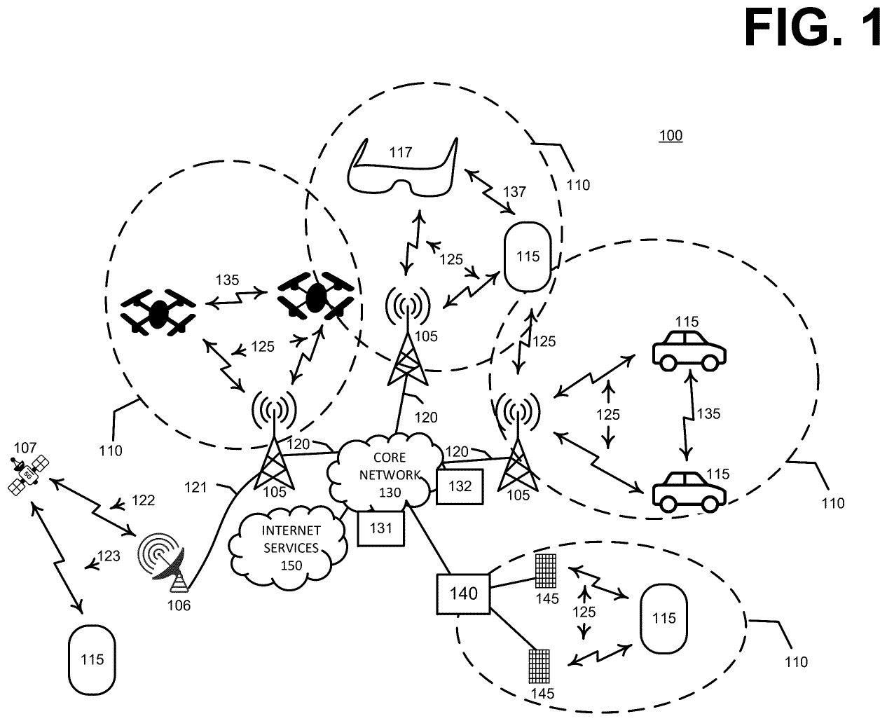

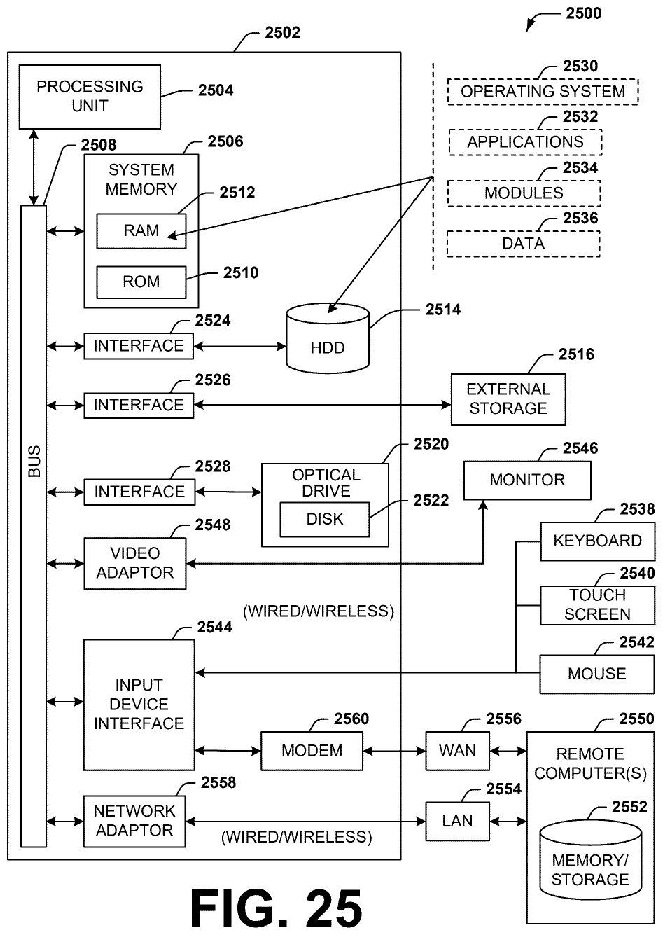

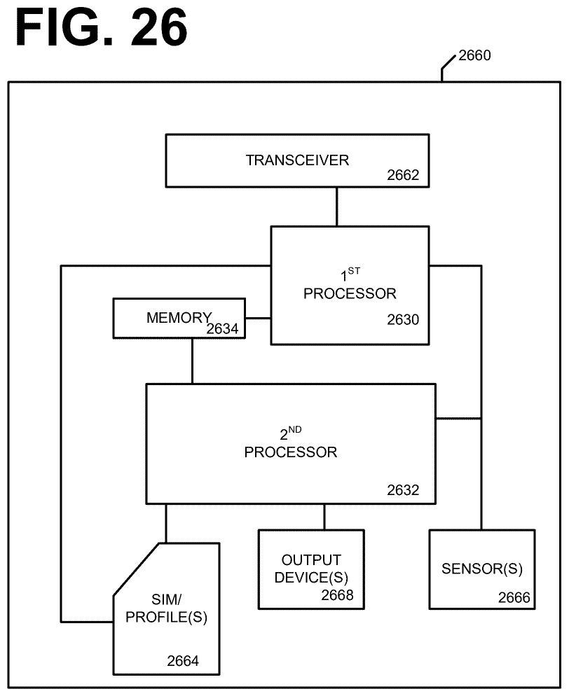

Turning now to the figures, FIG. 1 illustrates an example of a wireless communication system 100. The wireless communication system 100 may include one or more base stations 105, one or more user equipment (“UE”) devices 115, and core network 130. In some examples, the wireless communication system 100 may comprise a long-range wireless communication network, that comprises, for example, a Long-Term Evolution (LTE) network, an LTE-Advanced (LTE-A) network, an LTE-A Pro network, or a New Radio (NR) network. In some examples, the wireless communication system 100 may support enhanced broadband communications, ultra-reliable (e.g., mission critical) communications, low latency communications, communications with low-cost and low-complexity devices, or any combination thereof. As shown in the figure, examples of UEs 115 may include smart phones, laptop computers, tablet computers, automobiles or other vehicles, or drones or other aircraft. Another example of a UE may be a virtual reality/extended reality appliance 117, such as smart glasses, a virtual reality headset, an augmented reality headset, and other similar devices that may provide images, video, audio, touch sensation, taste, or smell sensation to a wearer. A UE, may transmit or receive wireless signals with a RAN base station 105 via a long-range wireless link 125, or the UE may receive or transmit wireless signals via a short-range wireless link 137, which may comprise a wireless link with another UE device 115, such as a Bluetooth link, a Wi-Fi link, and the like. A RAN 105, or a component thereof, may be implemented by one or more computer components that may be described in reference to FIG. 25. A UE may comprise components described in reference to FIG. 26

Continuing with discussion of FIG. 1, base stations 105, which may be referred to as radio access network nodes or cells, may be dispersed throughout a geographic area to form the wireless communication system 100 and may be devices in different forms or having different capabilities. The base stations 105 and the UEs 115 may wirelessly communicate via one or more communication links 125. Each base station 105 may provide a coverage area 110 over which UEs 115 and the base station 105 may establish one or more communication links 125. Coverage area 110 may be an example of a geographic area over which a base station 105 and a UE 115 may support the communication of signals according to one or more radio access technologies.

UEs 115 may be dispersed throughout a coverage area 110 of the wireless communication system 100, and each UE 115 may be stationary, or mobile, or both at different times. UEs 115 may be devices in different forms or having different capabilities. Some example UEs 115 are illustrated in FIG. 1. UEs 115 described herein may be able to communicate with various types of devices, such as other UEs 115, base stations 105, or network equipment (e.g., core network nodes, relay devices, integrated access and backhaul (IAB) nodes, or other network equipment), as shown in FIG. 1.

Base stations 105 may communicate with the core network 130, or with one another, or both. For example, base stations 105 may interface with core network 130 through one or more backhaul links 120 (e.g., via an S1, N2, N3, or other interface). Base stations 105 may communicate with one another over the backhaul links 120 (e.g., via an X2, Xn, or other interface) either directly (e.g., directly between base stations 105), or indirectly (e.g., via core network 130), or both. In some examples, backhaul links 120 may comprise one or more wireless links.

One or more of base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a bNodeB or gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, a personal computer, or a router. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or smart meters, among other examples.

UEs 115 may be able to communicate with various types of devices, such as other UEs 115 that may sometimes act as relays as well as base stations 105 and the network equipment including macro eNBs or gNBs, small cell eNBs or gNBs, or relay base stations, among other examples, as shown in FIG. 1.

UEs 115 and base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. Wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling, or control signaling, that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by UEs 115. A carrier may be operated in a standalone mode where initial acquisition and connection may be conducted by UEs 115 via the carrier, or the carrier may be operated in a non-standalone mode where a connection is anchored using a different carrier (e.g., of the same or a different radio access technology).

Communication links 125 shown in wireless communication system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications e.g., in a TDD mode).

A carrier may be associated with a particular bandwidth of the radio frequency spectrum, and in some examples the carrier bandwidth may be referred to as a “system bandwidth” of the carrier or the wireless communication system 100. For example, the carrier bandwidth may be one of a number of determined bandwidths for carriers of a particular radio access technology (e.g., 1.4, 3, 5, 10, 15, 20, 40, or 80 megahertz (MHZ)). Devices of the wireless communication system 100 (e.g., the base stations 105, the UEs 115, or both) may have hardware configurations that support communications over a particular carrier bandwidth or may be configurable to support communications over one of a set of carrier bandwidths. In some examples, the wireless communication system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE. A wireless communications resource may refer to a combination of a radio frequency spectrum resource, a time resource (e.g., a search space), or a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for a UE 115 may be restricted to one or more active BWPs.

The time intervals for base stations 105 or UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and Nr may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods e.g., depending on the length of the cyclic prefix prepended to each symbol period). In some wireless communication systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communication system 100 and may be referred to as a transmission time interval (TTI). In some examples, the TTI duration (e.g., the number of symbol periods in a TTI) may be variable. Additionally, or alternatively, the smallest scheduling unit of the wireless communication system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of UEs 115. For example, one or more of UEs 115 may monitor or search control regions, or spaces, for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115. Other search spaces and configurations for monitoring and decoding them are disclosed herein that are novel and not conventional.

A base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of a base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., UEs 115 in a closed subscriber group (CSG), UEs 115 associated with users in a home or office). A base station 105 may support one or multiple cells and may also support communications over the one or more cells using one component carrier, or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communication system 100 may include, for example, a heterogeneous network in which different types of the base stations 105 provide coverage for various geographic coverage areas 110 using the same or different radio access technologies.

The wireless communication system 100 may support synchronous or asynchronous operation. For synchronous operation, the base stations 105 may have similar frame timings, and transmissions from different base stations 105 may be approximately aligned in time. For asynchronous operation, base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communication system 100 may be configured to support ultra-reliable communications or low-latency communications, or various combinations thereof. For example, the wireless communication system 100 may be configured to support ultra-reliable low-latency communications (URLLC) or mission critical communications. UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). Communication link 135 may comprise a sidelink communication link. One or more UEs 115 utilizing D2D communications, such as sidelink communication, may be within the geographic coverage area 110 of a base station 105. Other UEs 115 in such a group may be outside the geographic coverage area 110 of a base station 105 or be otherwise unable to receive transmissions from a base station 105. In some examples, groups of UEs 115 communicating via D2D communications may utilize a one-to-many (1:M) system in which a UE transmits to every other UE in the group. In some examples, a base station 105 facilitates the scheduling of resources for D2D communications. In other cases, D2D communications are carried out between UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more RAN network nodes (e.g., base stations 105) using vehicle-to-network (V2N) communications, or with both. In FIG. 1, vehicle UE 116 is shown inside a RAN coverage area and vehicle UE 118 is shown outside the coverage area of the same RAN. Vehicle UE 115 wirelessly connected to the RAN may be a sidelink relay to in-RAN-coverage-range vehicle UE 116 or to out-of-RAN-coverage-range vehicle UE 118.

The core network 130 may provide user authentication, access authorization, tracking, Internet Protocol (IP) connectivity, and other access, routing, or mobility functions. Core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for UEs 115 that are served by the base stations 105 associated with core network 130. User IP packets may be transferred through the user plane entity, which may provide IP address allocation as well as other functions. The user plane entity may be connected to IP services 150 for one or more network operators. IP services 150 may comprise access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices e.g., radio heads and ANCs) or consolidated into a single network device (e.g., a base station 105).

The wireless communication system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHZ.

The wireless communication system 100 may also operate in a super high frequency (SHF) region using frequency bands from 3 GHz to 30 GHZ, also known as the centimeter band, or in an extremely high frequency (EHF) region of the spectrum (e.g., from 30 GHz to 300 GHz), also known as the millimeter band. In some examples, the wireless communication system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communication system 100 may utilize both licensed and unlicensed radio frequency spectrum bands. For example, the wireless communication system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as base stations 105 and UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

Base stations 105 or UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, a base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by a base station 105 in different directions and may report to the base station an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). A UE 115 may report feedback that indicates precoding weights for one or more beam directions, and the feedback may correspond to a configured number of beams across a system bandwidth or one or more sub-bands. A base station 105 may transmit a reference signal (e.g., a cell-specific reference signal (CRS), a channel state information reference signal (CSI-RS)), which may be precoded or unprecoded. A UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communication system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

### Connected Mode AI Driven Beam Management and Dynamic Reporting.

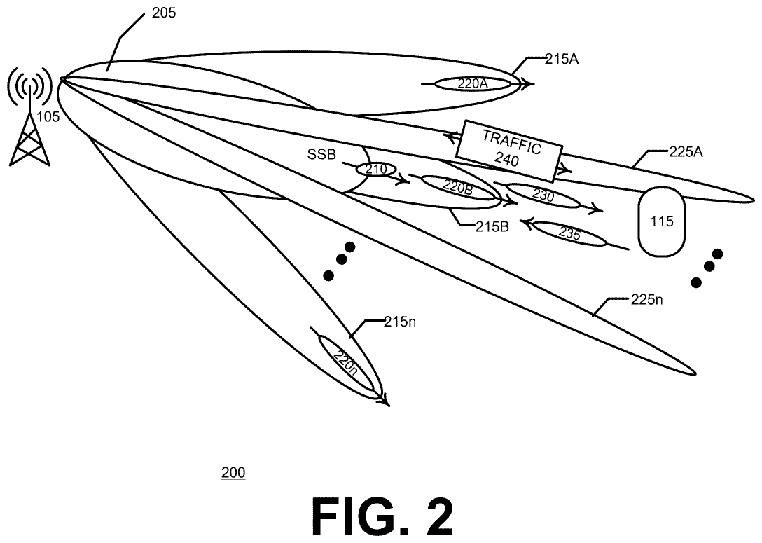

Turning now to FIG. 2, environment 200 may comprise a radio network node 105 and user equipment 115. User equipment 115 may represent more than one user equipment. One user equipment is illustrated for purposes of clarity and simplicity. RAN node 105 may transmit, toward connected-mode user equipment 115 via a downlink radio interface link as part of a radio resource control (“RRC”) connection establishment setup or via a downlink control information (“DCI”), connected-mode downlink beam reporting configuration information message 230. Beam reporting message 230 may be referred to as an artificial-intelligence-driven (“AI-driven”) beam reporting message. Message 230 may comprise at least one indication indicative of at least one measurement beam 215. Measurement beams 215 may correspond to a Set B of beams and may be referred to as Set B measurement beams.

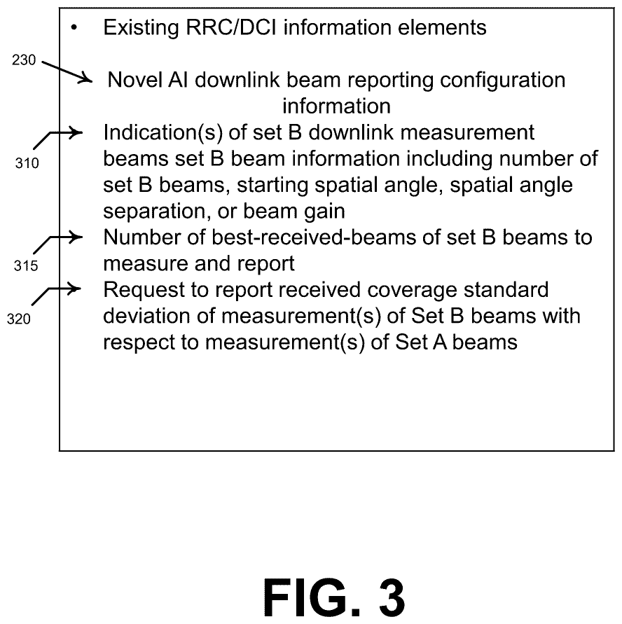

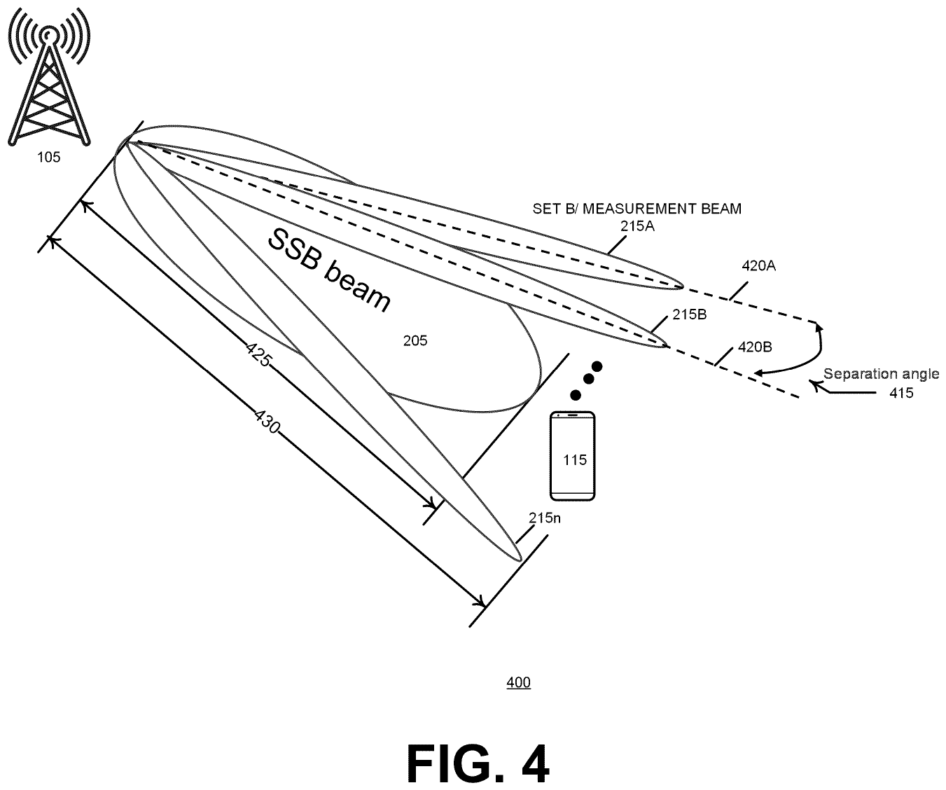

Message 230 may indicate parameter values corresponding to at least one measurement beam 215, with respect to which UE 115 is to measure at least one signal parameter corresponding to at least one measurement beam signal 220 and report measured signal parameter measurement values corresponding to the measurement beams, via a beam measurement report 235. Message 230 may comprise in field 310 (shown in FIG. 3) at least one measurement beam parameter indication indicative of at least one measurement beam parameter. The at least one measurement beam parameter indicated in field 310 may comprise at least one measurement beam direction indication indicative of at least one beam direction corresponding to at least one measurement beam (e.g., direction 420A corresponds to measurement beam 215A shown in FIG. 4), at least one measurement beam spatial angle (e.g., angle 415 corresponding to an angle between beam direction 420A and 420B shown in FIG. 4), or at least one measurement beam measurement beam gain (e.g., an indication of beam gain 430 shown in FIG. 4). In field 315, message 230 may comprise a beam reporting number indication indicative of a number of best-received-beam measurement values corresponding to measurement beams 215 to be reported via message 235. Message 230 may comprise, in field 320, a request indication indicative of a request that UE 115 report a least one difference value corresponding to at least one measurement value corresponding to measurement beams 215 as compared to a delivery beam 225, determined by RAN 105, used to deliver traffic 240 to UE 115, wherein the delivery beam is determined based on measurement beam signal values measured by UE 115, and transmitted to RAN 105 via message 235. The difference value may be based on a standard deviation of measured signal strength values corresponding to measurement beams 215. Information elements indicated by field 310 may define measurement beams 215 such that UE 115 can measure signals 220 corresponding thereto. Information indicated by field 315 may be indicative to UE 115 to report measured signal parameter value(s) corresponding to a best measurement beam 215 (e.g., a measurement beam having a strongest signal strength as measured by UE 115) or field 315 may comprise information indicative to UE 115 to report measured signal parameter values corresponding to a configured number (e.g., a reporting number) of best measurement beams. For example, if a reporting number indicated in field 315 is ten, responsive to receiving message 230 and measuring signal parameter values corresponding to multiple measurement beams 215A-215n, UE 115 would report, via report message 235, the ten highest signal strength values corresponding to beams 215 and would include in report 235 ten beam identifiers, for example ten beam indices, indicative of ten measurement beams 215 corresponding to the ten highest signal strength values. Because signal strength values reported via report 235 may be used by RAN 105 to update, or train, a delivery beam determining learning model, the more comprehensive report 235 is with respect to a number of signal strength measurement values corresponding to measurement beams 215 the better trained a learning model executing at RAN 105 may be and thus the more measured values reported via report 235 the better the learning model may perform in determining, or predicting, a delivery beam 225 to be used to deliver traffic 240 to UE 115.

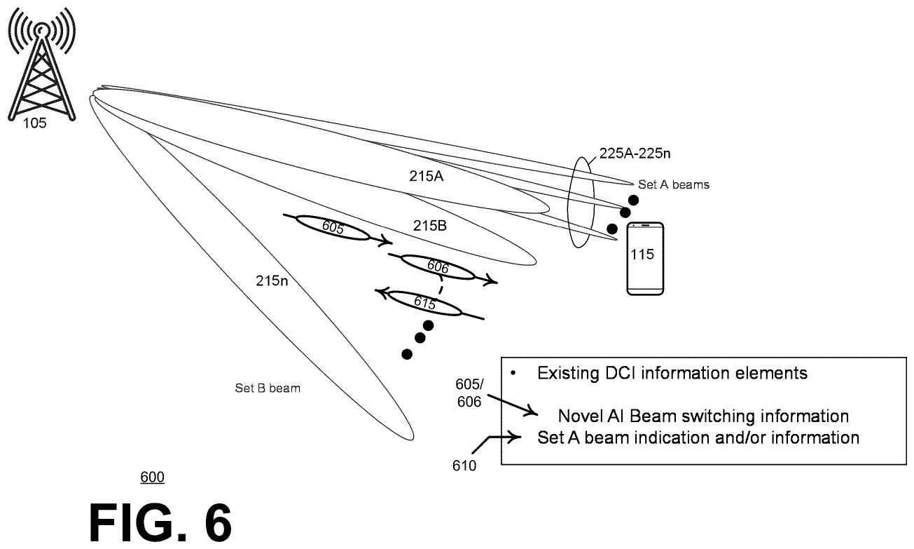

However, reporting of multiple best beams may increase uplink control channel overhead/resources being used to facilitate delivery of report 235. During periods of heavy network usage, RAN 105 may indicate to UE 115, via field 315, to only report, via report message 235, a strongest signal strength value corresponding to a single best measurement beam 215, whereas during lighter network usage, the RAN may indicate to the UE to report multiple measured signal strength value corresponding to multiple measurement beams 215 to potentially achieve better accuracy in training a delivery beam determining learning model executing at the RAN. If a delivery beam learning model being executed by RAN 105 determines, based on information indicated in message 325, that delivery beam 225A is an optimal delivery beam of beams 225A-225n, an indication in field 320 may facilitate RAN 105 obtaining, from UE 115, a deviation, or difference, of signal strength measurements corresponding to beam 225A and measurement beam 215B, which is shown in FIG. 2 as being associated with (e.g., overlapping with) beam 225A. Reporting of a signal strength difference between a predicted delivery beam 225 and an associated measurement beam 215 may facilitate RAN node 105 being made aware of the real-time performance of a delivery beam determining learning model. For example, if a prediction of delivery beam 225A is accurate, a received coverage level/signal strength value determined by UE 115 and corresponding to delivery beam 225A should be significantly greater than a signal strength corresponding to measurement beam 215B. If a deviation, or difference, corresponding to signal strengths associated with beam 225A and 215B and reported by UE 115 to RAN 105 (e.g., via report 615 described in reference to FIG. 6) is less than a configured criterion, RAN node 105 may determine a delivery beam 225 different than beam 225A to use to delivery traffic with respect to UE 115.

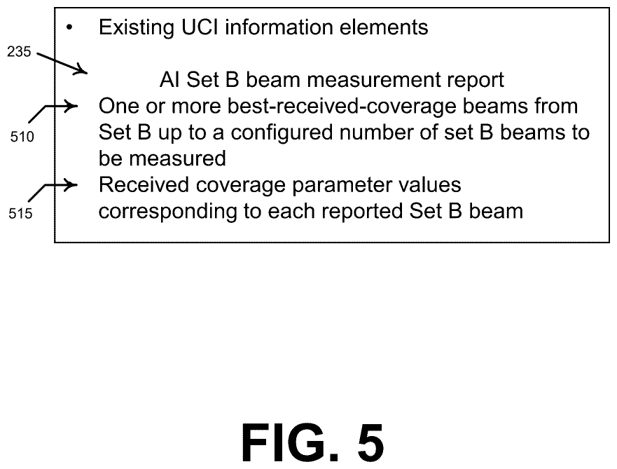

RAN node 105 may transmit measurement beams 215, or signals 220 corresponding thereto, according to timing, frequency, and spatial configuration information indicated by configuration information indicated by message 320. RAN node may receive report 235 from connected-mode UE 115 via an uplink radio interface link as part of uplink control information (“UCI”) signaling. As shown in FIG. 5, a Set B measurement beam measurement report 235 may comprise in field 510 at least one indication of at least one best-received-coverage measurement beam 215 (e.g., at least one beam identifier indicative of at least one measurement beam having a highest or strongest signal strength value as measured by UE 115) up to reporting number of beams as configured via field 315 of message 320. In field 515 shown in FIG. 5, report message 325 may comprise respective received coverage level(s) corresponding to each at least one beam indicated, or identified, in field 510. RAN node 105 may update, train, or retrain, an active beam management AI model, which may be referred to as delivery beam determining learning model, based on signal strength measurement values received via message 325. RAN node 105 may determine, or predict, a best active beam (e.g., a best delivery beam 225), from predetermined delivery beams (which may be referred to as Set A beams) to use to resume delivery of traffic with respect to UE 115.

As shown in FIG. 6, RAN node 105 may transmit, toward active, connected-mode UE 115, using DCI signaling, a beam switching information message 605 indicative of beam information 610. Beam information 610 may comprise an indication of at least one beam parameter value corresponding to a predicted best delivery beam, for example beam 225A shown in FIG. 2. The at least one beam parameter value indicted in field 610 may comprise an identifier, or index, associated with a determined/predicted delivery beam. The at least one beam parameter value indicated in field 610 may comprise delivery beam information corresponding to a determined/predicted delivery beam, for example, beam spatial information, (e.g., a spatial angular direction), or gain information. Accordingly, UE 115 may adopt for traffic delivery, a refined delivery beam, selected by RAN 105 from a set of delivery beams, with respect to which the UE has not determined, or measured, signal strength corresponding thereto, because the selected/determined delivery beam is determined by RAN 105 using a learning model. RAN node 105 may continue delivery of traffic with respect to UE 115 via a delivery beam predicted by the learning model.

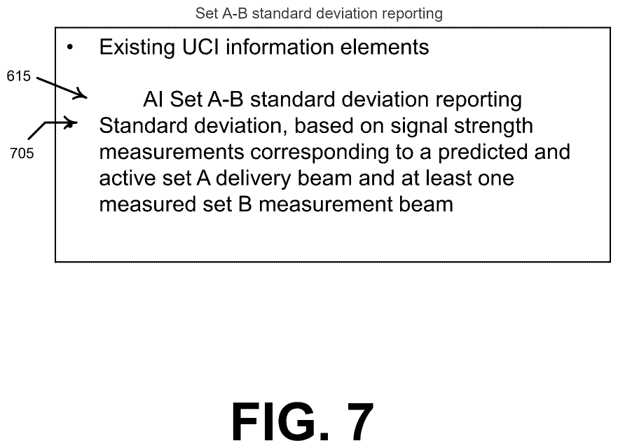

RAN node 105 may receive, over an uplink radio interface link as part of a UCI signaling message, report message 615, which may indicate a standard deviation in signal strength/coverage level between a received coverage level value corresponding to delivery beam determined by RAN 105 and a received coverage level value corresponding to an actually-measured Set B measurement beam. Transmitting, by UE 115, of report 615 may be triggered by at least one condition. For example, UE 115 may determine a standard deviation between a signal strength measurement value corresponding to a delivery beam and a signal strength measurement value corresponding to a measurement beam only when the coverage deviation is larger than a configured threshold, which may be configured via field 320 in message 230. Upon receiving a difference report 615, RAN 105 may determine a different delivery beam and indicate the new delivery beam to UE 115 via a message 606, which may comprise similar information as message 605. Message 606 is shown in FIG. 6 connected via a dashed line to report 615 to illustrate that the determining and indicating, via message 606, of a new/different delivery beam than the beam indicated in message 605 may be responsive to RAN 105 receiving report 615. A standard deviation value may be reported in field 705 of report message 615 as shown in FIG. 7.

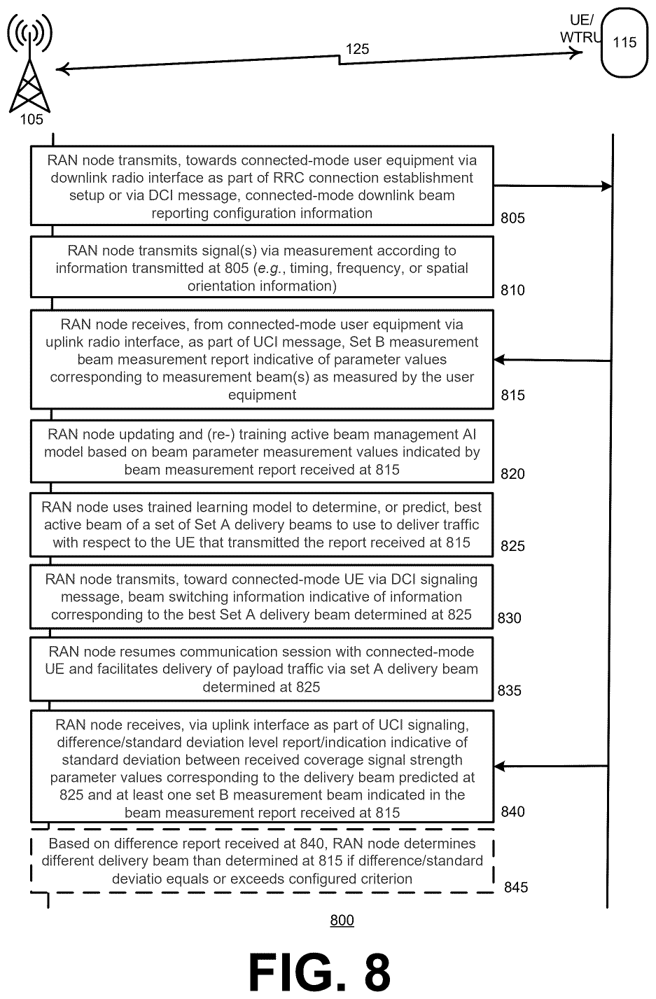

Turning now to FIG. 8, the figure illustrates a timing diagram of an example embodiment method 800 to facilitate radio network node 105 receiving beam parameter measurement values measured or determined by UE 115 and training a beam determining learning mode with the measurement values. At act 805, RAN node 105 may transmit, toward connected-mode user equipment 115, via downlink radio interface link(s) 125 as part of a radio resource control (“RRC”) connection establishment setup message or as a downlink control information (“DCI”) message, connected-mode artificial-intelligence (AI)-driven downlink beam reporting configuration information message, such as message 230 described in reference to FIG. 2. Message 230 may comprise, at least one of: a set B of measurement downlink beam indications indicative of a set of set B beam information corresponding to Set B measurement beams, at least one starting spatial angle, and/or spatial angle separation, and/or beam gain or gain level indication corresponding to the indicted set B measurement beams; a number of best-received-beam(s) of the set of set B measurement beams, to be reported by UE 115 to RAN 105; or a request for reporting, by UE 115 to RAN 105 a difference value, for example a standard deviation value, between at least one measurement value corresponding to at least one Set B beam with respect to and a determined delivery beam to be determined by RAN node 105.

At act 810, RAN node 105 may transmit Set B downlink measurement beams (e.g., beams 215 shown in FIG. 2), or measurement signals (e.g., signals 220 shown in FIG. 2) via the measurement beams, according to timing, frequency, or spatial measurement beam parameter information that may have been indicated by a message 230 transmitted at act 805. At act 815, RAN node 105 may receive, from connected-mode user equipment device 115 via uplink radio interface link(s) 125, as part of an uplink control information (“UCI”) signaling, a Set B beam measurement beam measurement report 235. Report 235 may comprise at least one measurement beam measurement value, determined, or measured, by UE 115 which may comprise at least one of: at least one beast beam indications indicative of at least one beast beam, determined by UE 115, that corresponds to at least one best-received-coverage/signal strength parameter value. Measurement beam measurement parameter values may correspond to a single best beam as determined by user equipment 115 or may correspond to a number of best beams, which number may be configured via a message 230 received at act 805. Message 235 may comprise at least one received coverage level indication indicative of at least one parameter measurement value (e.g., a signal strength value or a signal to interference and noise ratio value) corresponding to each of the at least one indicated best beam.

At act 820, RAN node 105 may update, or re-train, an active beam management artificial intelligence learning model based on at least one parameter measurement value, corresponding to the at least one best measurement beam, indicated in message 235.

At act 825, RAN node 105 may determine, using the artificial intelligence learning model updated, trained, or retrained at act 820, to determine, to predict, or to select from a set of delivery beams, a predicted best active beam as a determined delivery beam to use to deliver traffic with respect to user equipment 115. At act 830, RAN node 105 may transmit, towards active/connected-mode UE 115 using DCI signaling, a beam switching information message, for example beam switching message 605 described in reference to FIG. 6 indicative of beam information corresponding to the determined delivery being determined, or predicted, at act 825. The predicted, or determined, delivery beam determined at act 825 may comprise at least one of: at least one beam identifier, index, or indication, and/or at least one beam spatial information indication (e.g., an indication of at least on spatial angular direction or an indication of at least one beam gain corresponding to the determined delivery beam). At act 835, RAN node 105 may resume a communication session with UE 115 via the determined delivery beam and may resume delivery of payload traffic corresponding to the communication session via the determined delivery beam. At act 840, RAN node 105 may receive, via an uplink interface link(s) 125 as part of an UCI signaling message (e.g., message 615 shown in FIG. 6), a standard deviation value (e.g., a signal strength or level indication) indicative of a signal strength difference, or another signal parameter value difference, between a received coverage level corresponding to the predicted/determined delivery beam determined at that 825 and a received coverage level corresponding to a measurement beam indicated in a report 235 received from user equipment 115 at act 815. At act 845, RAN node 105 may use a parameter value difference indicated in the report received at act 840 to determine a different delivery beam than the delivery beam determined at act 825. Responsive to receiving a difference value report message at act 840, the RAN node may transmit and updated beam switching information message indicative of an updated, or different delivery beam, determined based on information indicated and the message received at act 840. Act 845 is illustrated in dashed lines to show correspondence to message 606 being shown in FIG. 6 connected to report message 615 with a dashed line to indicate that the transmitting of report message 606 may be based on information indicated by report message 615 and to indicate that a message 606 may not be transmitted if a difference/standard deviation indicated in message 615 satisfies a configured criterion (e.g., a standard deviation indicated by report message 615 is less than a configured criterion).

### Idle Mode Beam Measurement, Reporting, and Training.

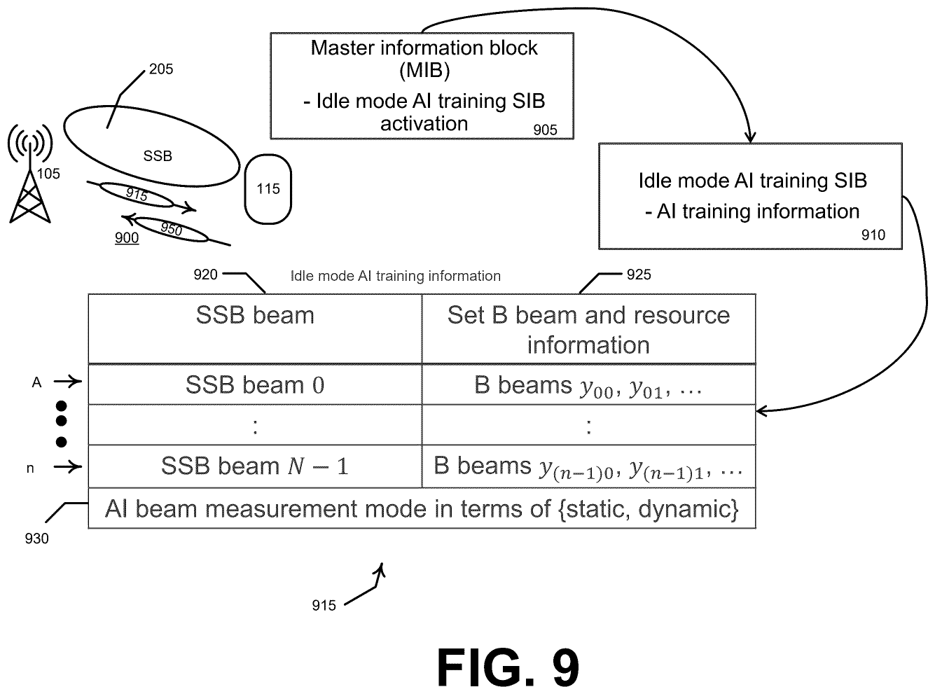

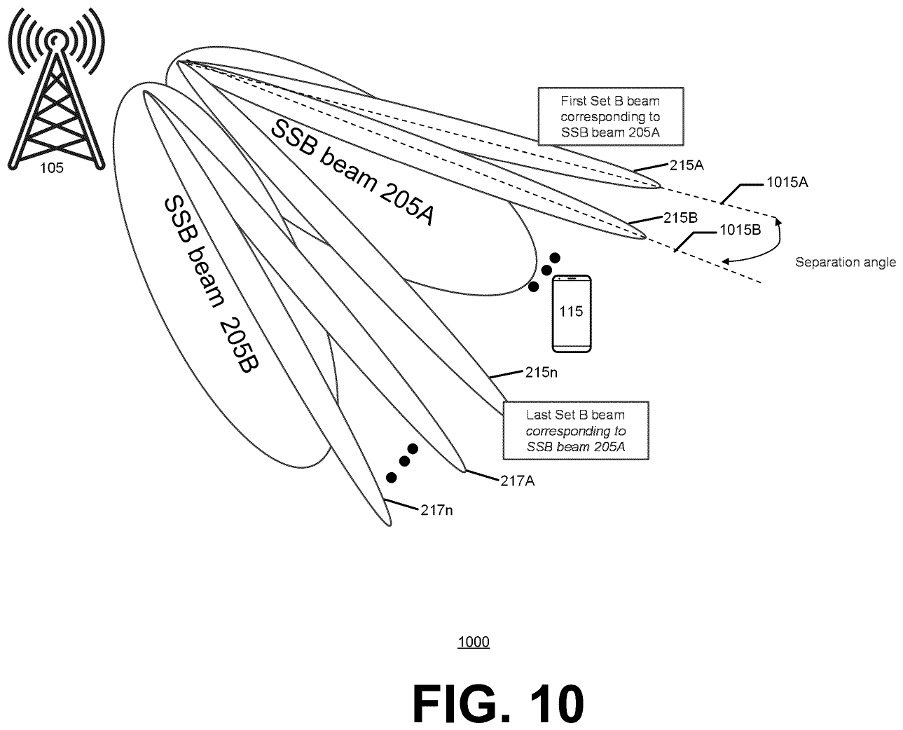

FIG. 9 illustrates an example environment 900 with a radio network node training a learning model based on signal measurement values reported by idle-mode user equipment. RAN node 105 may transmit, towards idle-mode device(s) 115 via the downlink radio interface link(s) as part of broadcast information (e.g., as part of a system information block (“SIB”) message 910 indicated by Master Information Block message 905), idle-mode artificial-intelligence-driven beam measurement configuration information 915. SIB 910 may comprise, or may indicate, information 915. Information 915 may comprise in field(s) 920A-920n, for each at least one available downlink beam usable to broadcast a synchronization signal block (“SSB”) messages (e.g., for each SSB beam 205 shown in FIG. 10), at least one indication of the at least one SSB beam. In field(s) 925A-925n, for each SSB beam indication in a field 920, message 915 may comprise at least one indication of at least one set B downlink measurement beam (e.g., beam(s) 215 shown in FIG. 10) usable for measurement, sampling, by a user equipment that is operating in an idle mode. A field 925 may comprise, for each corresponding SSB beam indicated in a field 920, one or more indications of one or more measurement beams of a set of measurement beams associated with the corresponding SSB beam indicated in field 920. For each measurement beam 215 indicated in a field 925, the field 925 may comprise beam parameters defining the respective one or more measurement beams. For example, if field 920A shown in FIG. 9 is indicative of SSB beam 205A shown in FIG. 10, field 925A may indicate at least one angular direction indication corresponding to at least one measurement beam indicated in field 925, for example angular direction values indicative of directions 1015A and 1015B shown in FIG. 10. Field 925A may comprise at least one beam gain value corresponding to the at least one indicated measurement beam 215A-215n.

In field 930, information 915 may comprise a beam reporting mode indication in terms of a static reporting mode or a dynamic reporting mode. A static reporting mode may be indicative to a user equipment that the user equipment is to always report Set B beam signal measurement values when the measurement beam signals (e.g., signals 220 shown in FIG. 2) are available and detected by the user equipment. A dynamic reporting mode may be indicative that a user equipment is to only report Set B measurement beam parameter measurement values when a minimum received coverage standard deviation criterion/threshold is satisfied, wherein the standard deviation criterion may be satisfied by a standard deviation value corresponding to signal strength parameter values corresponding to Set B measurement beams and an SSB beam to which the Set B measurement beams correspond being determined to equal or exceed the criterion. Measurement beam information indicated in a field 925 may comprise timing or frequency resource information corresponding to each Set B measurement beam indicated in the field 925. Unlike AI training and beam determining described above that may occur while a user equipment is operating in a connected mode, wherein a best SSB beam determined by a connected-mode UE is already available to, or ‘known’ by, a RAN node, when a user equipment is operating in an idle mode a RAN node does not ‘know’ where an idle mode user equipment is located and therefore idle-mode AI beam training may be repeated via all SSB beams corresponding to the RAN node.

The beam measurement mode indication may facilitate a RAN node in avoiding receiving reports from a large number of idle-mode user equipment devices transmitting measurement beam measurement reports. For example, a user equipment that is close to a RAN node may not experience, or determine, significant coverage level difference/signal strength difference between a signal strength corresponding to a determined best SSB beam and any of Set B measurement beams indicated by information 915 (e.g., beam refinement may not benefit the user equipment if the user equipment is very close to the RAN node such that using measurement beam parameter value measured by a user equipment to select a refined delivery beam may not provide a better, or stronger, signal strength than a measurement beam that may have a lower gain and that may not be as directionally aligned with the user equipment as a refined beam may be). Thus, reporting of measurement beam measurement values by a user equipment that is located close to a RAN node device may not provide sufficient measurement that is useful to train a learning model. Accordingly, a user equipment 115 may determine not to report measurement beam signal parameter measurement values to a RAN node 105 if the user equipment is configured, by a dynamic reporting mode indication, to avoid participating in AI beam training measurement and reporting if a difference value corresponding to and SSB beam and a measurement beam associated therewith is determined by the user equipment to be lower than a configured reporting criterion/threshold.

As shown in FIG. 10, UE/WTRU/device 115 may decode available SSB beams 205A and 205B and determine SSB beam 205A as delivering the largest/strongest received coverage level, (e.g., UE 115 determines beam 205A a best SSB beam). If field 920A is indicative of SSB beam 205A and if field 920n is indicative of SSB beam 205B, UE/WTRU/device 115 may determine, from fields 925A and 925n in information 915, Set B measurement beams 215A-215n as corresponding to SSB bean 205A and set B measurement beams 217A-217n as corresponding to SSB beam 205B. If UE 115 determines SSB beam 205A as a best SSB beam, the UE may measure signal parameter values corresponding to measurement beams 215A-215n indicated in field 925A and report the measured signal parameter values to RAN 105.

For each synchronization signal block beam 205A and 205B, RAN node 105 may transmit and broadcast Set B measurement beams of respective sets 215A-215n and 217A-217n to facilitate beam signal measurements that may be used to train or retrain a delivery beam determining artificial intelligence machine learning model executing at the RAN node. User equipment 115 may determine SSB beam 205A to be a best SSB beam based on a measured signal strength corresponding to SSB beam 205A being stronger than one or more measured signal strength value(s) corresponding to SSB beams adjacent to SSB beam 205A, for example the user equipment may determine that a signal strength corresponding to SSB beam 205A is stronger than a signal strength corresponding to SSB beam 205B. User equipment 115 may receive and decode signals transmitted via the Set B measurement beams 215 corresponding to SSB 205A and determine a received coverage level (e.g.; a signal strength of a received reference signal) corresponding to each Set B measurement beam.

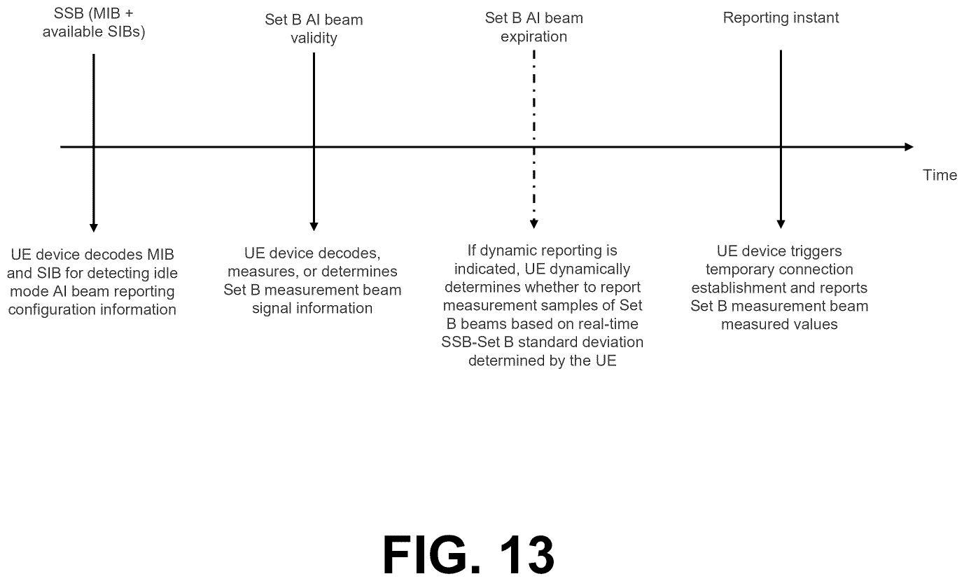

Based on field 930 in information 915 shown in FIG. 9 being indicative of dynamic beam measurement reporting, as shown in the timeline illustrated by FIG. 13, UE/WTRU/device 115 may calculate and determine a largest standard deviation between any of the received Set B beams 215 with respect to best SSB beam 205A (shown in FIG. 10). (In FIG. 13, requesting of connection establishment is shown with a broken line to illustrate that a UE may not request connection establishment if a reporting criterion is not satisfied by a difference value corresponding to at least one signal value determined with respect to at least one measurement beam and a signal value determined with respect to a best SSB beam.) Based on the determined standard deviation being determined to equal or exceed a configured difference/standard deviation threshold/criterion, UE/WTRU/device may transmit a request message requesting establishment of an uplink-only connection. The connection establishment request may comprise a service cause indication indicative of ‘AI beam measurement reporting’, ‘reduced-capability purpose’ or ‘uplink-only.’ The RAN node may determine, based on the service cause indication, to establish a reduced-capability connection with the user equipment for the purpose of receiving a report indicative of signal measurement values corresponding to the set the measurement beams 215. The reduced-capability connection may facilitate transmission of uplink control channel traffic but may not facilitate delivery of downlink traffic from the RAN node to the UE. As shown in FIG. 9, UE 115 may transmit, via the reduced-capability connection, report 950 indicative of measurement beam signal measurement values determined by the UE. After transmitting to RAN node 105, UE WTRU/device 115 may terminate the reduced-capability connection and return to idle-mode operation. If field 930 in information 915 is indicative of static beam measurement reporting, UE 115 may avoid calculating, or determining, a standard deviation between at least one Set B measurement beam 215 and a determined best SSB beam and may transmit to RAN node 105 measurement report 950 without determining whether a standard deviation equals or exceeds a configured standard deviation threshold.

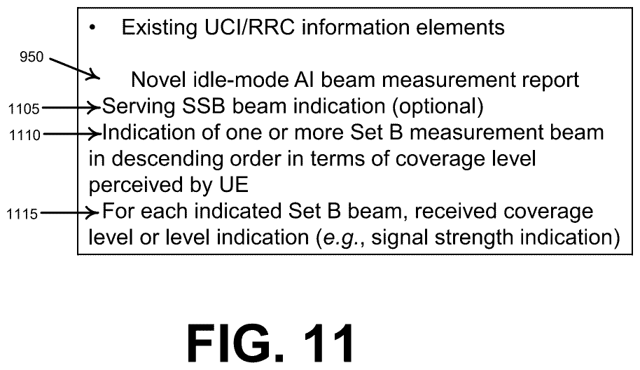

As shown in FIG. 11, report 950 may comprise in field 1105 an SSB indication of an SSB beam 205 determined by the UE to be a best SBB. Report 950 may comprise in field 1110, at least one indication, identifier, or index indicative of at least one of measurement beams 215 with respect to which the UE measured, or determined signal parameter values, that corresponds to the best SSB beam indicated in field 1105. The at least one measurement beam 215 indicated in field 1110 may be listed in descending order according to signal strength values determined by the UE. In field 1115, message 950 may comprise, for each measurement beam 215 indicated in field 1110, a received coverage level, level indication, or signal strength value determined or measured by the UE. Although UE 115 may include in field 1105 of report 950 an indication of a serving/best SSB beam with respect to which Set B measurement beam signal parameters are indicted in field 1115, a user equipment attempting connection establishment with a RAN may, according to conventional techniques, declare a best SSB beam. Thus, an indication of a best SSB in field 1105 may be unnecessary.

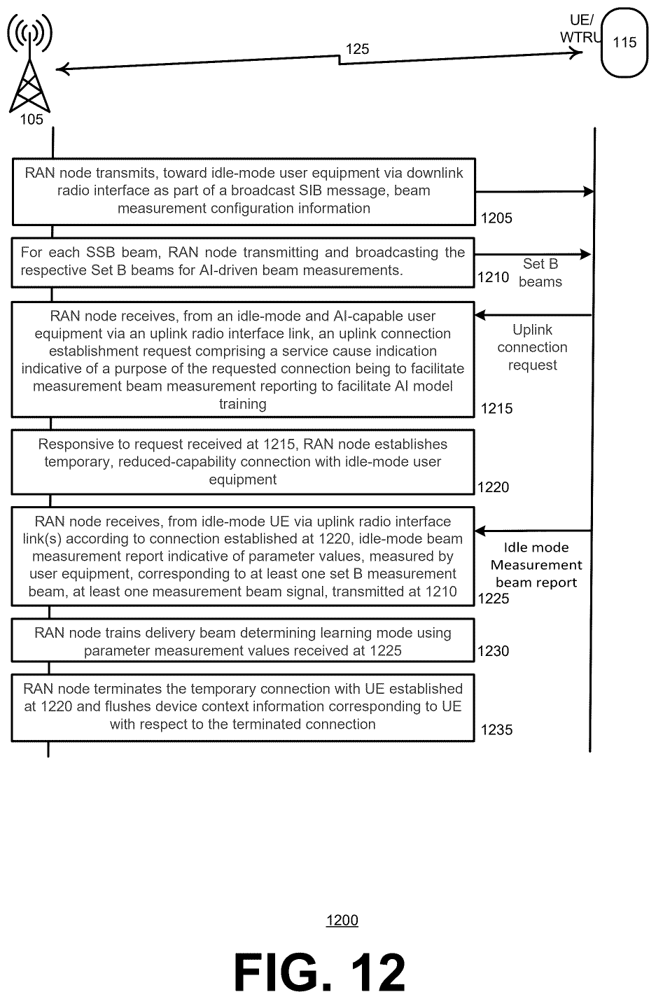

Turning now to FIG. 12, the figure illustrates a timing diagram of an example embodiment method 1200 to facilitate radio network node 105 receiving beam parameter measurement values measured or determined by UE 115 and training a beam determining learning mode with the measurement values. At act 1205, RAN node 105 may transmit, toward idle-mode user equipment 115, via downlink radio interface link(s) 125 as part of broadcast information, for example SIB message 910 shown in FIG. 9 that may be a SIB designed to contain, or indicate, measurement beam configuration information, for example information 915 shown in FIG. 9. The idle-mode beam measurement configuration information transmitted at act 1205 may comprise at least one of: with respect to each at least one available downlink beam usable by RAN 105 to broadcast synchronization signal block information, beam parameter information that may be indicative of, or that may define, at least one set B downlink measurement beam usable to transmit signals usable by UE 115 to determine beam parameter measurement samples, or values, corresponding to the at least one measurement beam. The beam parameter information transmitted at act 1205 may comprise, for each set of at least one Set B measurement beam, a number of measurement beams, an angular direction associated with at least one of the at least one measurement beam, or a beam gain associated at least one of the at least one measurement beam. The beam parameter information transmitted at act 1205 may comprise a beam measurement mode in terms of a static reporting mode or a dynamic reporting mode. A static reporting mode indication may be indicative that UE 115 is to always report Set B beam measured measurement beam parameter values (e.g., a signal strength value or a value related to a signal strength, for example a signal to noise ratio, a signal to interference ratio, or a signal to interference and noise ratio, and the like) in response to having received the beam parameter information transmitted at act 1205 if UE 115 has performed measurements with respect to the at least one set B measurement beam. A dynamic reporting mode indication may be indicative that UE 115 is to only report measured Set B measurement beam parameter values when a minimum received coverage/signal strength difference, or standard deviation, criterion/threshold is satisfied wherein the difference/standard deviation is determined based on at least one measured Set B measurement beam parameter value analyzed with respect to a signal strength value corresponding to a current/best/strongest SSB beam. The beam parameter information transmitted at act 1205 may comprise timing or frequency resource information associated with each of the at least one Set B measurement indicated by the beam parameter information with respect to all SSB beams that are available to, or detectable by, UE 115.

At act 1210, for each SSB beam corresponding to RAN node 105, the RAN node may transmit/broadcast Set B measurement beams, or Set B measurement beam signals, via the set B measurement beams indicated by the information transmitted at 1205. The Set B measurement beams, or signals transmitted according thereto, may be usable by UE 115 to determine beam measurement values, pertaining to the measurement beams, that may be usable to facilitate, by RAN 105, training of an artificial intelligence learning model that may be usable by RAN 105 to determine a delivery beam to facilitate delivery of traffic with respect to UE 115 or to facilitate delivery of traffic with respect to user equipment other than UE 115.

At act 1215, RAN node 105 may receive an uplink connection establishment request, from idle-mode AI-capable user equipment 115 via uplink radio interface link(s) 125, comprising a service cause indication indicative of AI beam measurement reporting as a cause for the requesting of connection establishment. At act 1220, RAN node 105 may accept the request received at act 1215 and establish a temporary connection with UE 115, which may be a reduced-capability connection that may only facilitate uplink transmission and which may be established for the purpose of receiving measurement information corresponding to set B measurement beam signals.

At act 1225, RAN node 105 may receive, from user equipment 115 according to the temporary connection established at act 1220, a beam measurement report (e.g., report 950 shown in in FIG. 9). The beam measurement report received it at 1225 may comprise at least one of: at least one indication indicative of at least one measurement beam index, or identifier, corresponding to at least one Set B measurement beam transmitted at act 1210 with respect to which user equipment 115 measured a beam parameter value. The at least one measurement beam index, or identifier, may be listed in the beam measurement report received at 1225 in a descending order according to a coverage level, or signal strength, corresponding to the indicated at least one measurement beam index, as determined or perceived by the user equipment. The beam measurement report received at act 1225 may comprise, for each indicated Set B measurement beam, a received coverage level/signal strength or level/signal strength indication.

At act 1230, RAN node 105 may train a delivery beam determining learning model using measured parameter values, corresponding to the at least one measurement beam, or at least one measurement beam signal associated therewith, received at act 1225. At act 1235, RAN node 105 may terminate the active reduced-capability connection established at act 1220 and flush context information corresponding to UE 115 and the terminated reduced-capability connection.

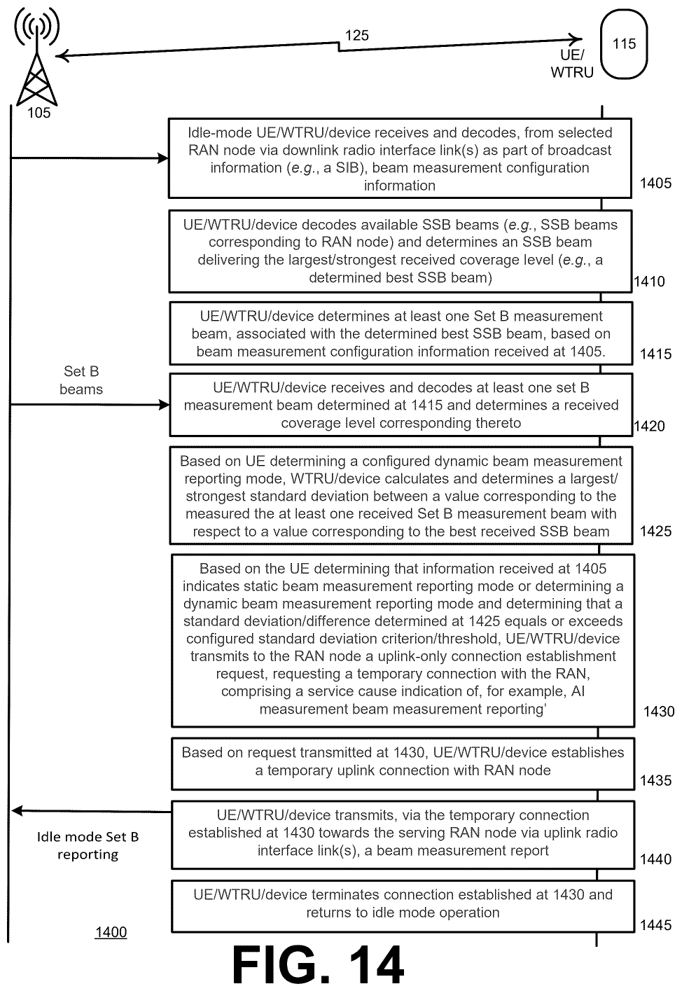

Turning now to FIG. 14, the figure illustrates a timing diagram of an example embodiment method 1400 to facilitate idle-mode user equipment 115 transmitting beam parameter measurement values measured, or determined by UE 115, to RAN node 105 to be used thereby to train a beam determining learning model with the measurement values. At act 1405, user equipment 115 may receive, from selected RAN node 105 via downlink radio interface link(s) 125 as part of broadcast information (e.g., a SIB), and decode idle-mode beam measurement configuration information. The idle-mode beam measurement configuration information may comprise at least one of: for each available downlink beam of SSB beams corresponding to RAN 105, a set of at least one SET B downlink measurement beams usable to facilitate transmission of signals for use by UE 115 to determine beam measurement values. The beam measurement configuration information may comprise, for each set of at least one Set B measurement beam, at least one measurement beam parameter, for example, a number of beams that compose, or make up, the set; an angular direction corresponding to at least one of the at least one measurement beam; or a beam gain corresponding to at least one of the at least one measurement beam. The beam measurement configuration information may comprise an indication of a static measurement beam reporting mode or a dynamic measurement beam reporting mode. A static reporting mode indication may be indicative that UE 115 is to always report at least one measured measurement beam parameter value at least one Set B beam measurement beam signal is detected by UE 115. A dynamic reporting mode indication may be indicative that UE 115 is only to report at least one measured measurement beam parameter value if UE 115 determines that a standard deviation determined by analyzing, by UE 115, at least one measured Set B measurement beam signal strength parameter value with respect to a determined best SSB beam is satisfied. The beam measurement configuration information may comprise timing parameter or frequency parameter information corresponding to, or defining, each of indicated Set B measurement beams for all SSB beams corresponding to RAN 105 that ac detectable by UE 115.

At act 1410, UE 115 may decode available SSB beam signals and determine an SSB beam delivering the largest/strongest received coverage level (e.g., a determined best SSB beam). At act 1415, UE/WTRU/device 115 may determine Set B measurement beams, associated with the determined best SSB beam, based on information received at act 1405 (e.g., based on timing or frequency parameter information received at 1405). At act 1420, UE/WTRU/device 115 may receive and decode signals transmitted/broadcast by RAN node 105 via the set B measurement beams determined at act 1415 and may determine a received coverage level/signal strength value corresponding to each of the at least one determined Set B measurement beam.

At act 1425, based on dynamic reporting mode being indicated by information received at act 1405, UE/WTRU/device 115 may calculate/determine a largest standard deviation value based on at least one measured signal parameter value corresponding to at least one of the at least one Set B measurement beam and at least one measured signal parameter value corresponding to the determined best SSB beam.

At act 1430, based on a static reporting mode being configured via information received at act 1405 or based on dynamic reporting mode being configured at act 1405 and a standard deviation difference determined at act 1425 being determined by UE 115 to equal or exceed a difference criterion/threshold or standard deviation criterion/threshold configured at act 1405, UE/WTRU/device 115 may trigger transmitting a connection establishment request for a temporary uplink-only connection. The connection establishment request transmitted at act 1430 may comprise a service cause indication of ‘AI beam measurement reporting’ to indicate to RAN 105 that the purpose of the connection being request is to facilitate transmitting, by UE 115 to RAN 105, a beam measurement report comprising measured measurement beam parameter values corresponding to the Set B measurement beams determined at 1415 and measured at 1420. At act 1435, based on the connection establishment request transmitted it act 1430, UE 115 may establish a temporary connection with RAN node 115, which may be a reduced-capability connection to the extent that the established connection may facilitate uplink transmission but the RAN node may not schedule downlink resources for downlink transmission to the UE.

At act 1440, UE/WTRU/device 115 may transmit a beam measurement report (e.g., report 950 shown in FIG. 9) toward serving RAN node 105 via uplink radio interface link(s) 125, comprising an indication of at least one measured beam index indicative of at least one Set B measurement beam with respect to which at least one beam parameter measurement value was determined by UE 115 at 1420. The at least one measured beam index may be indicated in the beam measurement report in descending order in terms of coverage level/signal strength determined/perceived by UE 115. The beam measurement report may comprise at least one signal strength/coverage level corresponding to the at least one measurement beam indicated by the at least one measurement beam index. At act 1445, UE/WTRU/device 115 may terminate the connection established at act 1435 and return to idle mode operation.

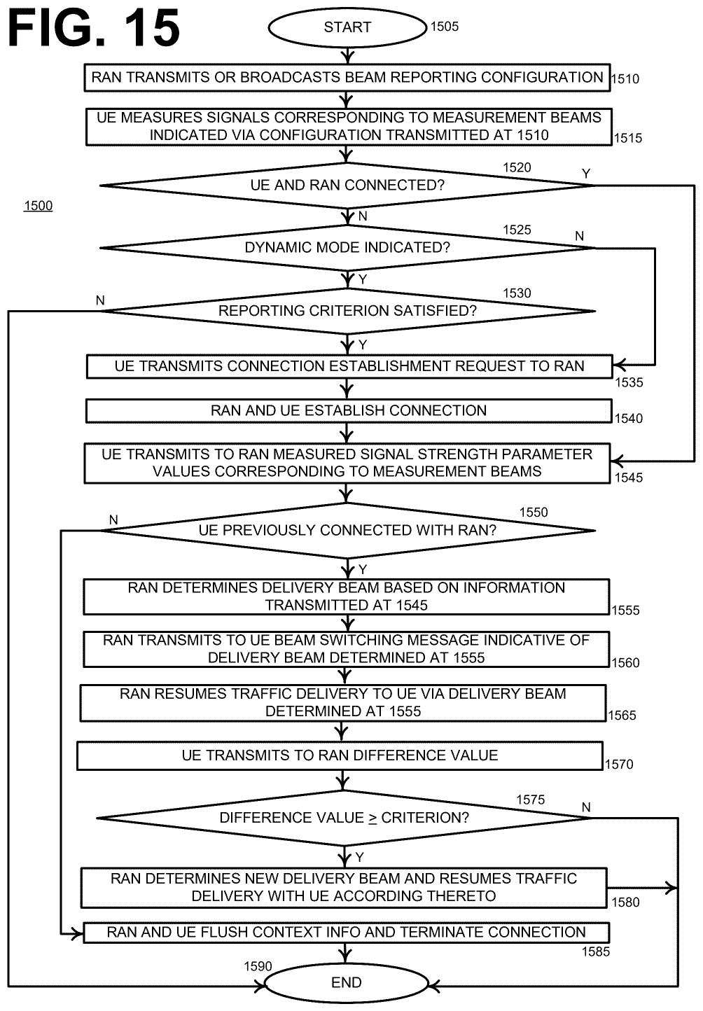

Turning now to FIG. 15, the figure illustrates a flow diagram of an example embodiment 1500. Method 1500 begins at act 1505. At act 1510, a radio network node, or a network element comprising, or corresponding to, a radio network node, may transmit or broadcast beam reporting configuration information. The radio network node may transmit the beam reporting configuration information, for example information 230 described in reference to FIG. 2, to a connected-mode user equipment via a connection that may already be established between the radio network node and the connected-mode user equipment. The connected-mode user equipment may use the beam reporting configuration information to determine at least one measurement beam to sample, or measure, a signal strength value corresponding thereto. The radio network node may broadcast the beam reporting configuration information, for example information 915 described in reference to FIG. 9, to be usable by idle-mode user equipment to determine measurement beams to sample, or measure, signal strength parameters corresponding thereto.

At act 1515, at least one user equipment may measure signals corresponding to measurement beams indicated by configuration information transmitted at act 1510. At act 1515, if a user equipment has established a connection with radio network node and thus is a connected mode user equipment, method 1500 advances to act 1545. At act 1545, the user equipment may transmit to the radio network node measured signal strength parameter values corresponding to measurement beam signals sampled, or measured, by the user equipment at act 1515. The measured signal strength parameter values may be transmitted by the user equipment to the radio node via a report 235 described in reference to FIG. 2. At act 1515, if the user equipment previously had a connection (e.g., the user equipment is a connected-mode user equipment with respect to the radio node), method 1500 advances to act 1555. At act 1555 the radio network node may determine a delivery beam based on information transmitted by the user equipment at act 1545. The radio network node may determine a delivery beam using an artificial intelligence learning model that may be trained using the information received at act 1545. The radio network node may determine a delivery beam using a previously trained artificial intelligence learning model that may have been trained by information received from the user equipment or using information received from other user equipment that may be geographically located near the user equipment. Thus, selection, or determining, of a delivery beam to be used to facilitate delivering traffic to, or from, the user equipment may be based on signal strength, radio channel characteristics, or other measured parameter values that correspond to a user equipment and a location of the user equipment with respect to the radio node. At act 1560, the radio network node may transmit to the connected-mode user equipment a beam switching message indicative of a delivery beam determined by the radio network node at act 1555. At act 1565, the radio network node may resume facilitating delivery of traffic to, or from, the user equipment via the delivery beam determined at act 1555.

In an example embodiment, at act 1570, the user equipment may transmit to the radio network node a difference value. The difference value transmitted at act 1570 may be indicative of a signal strength value difference between a signal strength value corresponding to the delivery beam determined at act 1555 and a measurement beam measured by the user equipment at act 1515. The difference value may be a standard deviation value determined based on a signal strength value corresponding to the delivery beam determined at 1555 and at least one measurement beam measured at act 1515. The standard deviation value may be based on a difference between a signal strength value corresponding to the delivery beam determined at act 1555 and a standard deviation of at least one measurement value corresponding to at least one measurement beam measured at act 1515. At act 1575, the radio network node may analyze the difference value transmitted by the user equipment at act 1570 with respect to a configured criterion to result in an analyzed difference value. If the radio network node determines that the analyzed different value equals or exceeds a configured criterion, indicating that the delivery beam indicated by the beam switching message transmitted by the radio network node to the user equipment at act 1560 differs from the at least one measurement beam measured at act 1515 by an amount at least equal to the criterion, method 1500 advances to act 1580. At act 1580, the radio network node may determine a new delivery beam to be used to deliver traffic with respect to the user equipment, and the radio network node may transmit another beam switching message indicative of the new, or updated, delivery beam, and may resume traffic delivery with respect to the user equipment via the new, or updated, delivery beam. Method 1500 advances from act 1580 to act 1590 and ends.

Returning to description of act 1520, if a user equipment that receives beam reporting configuration information transmitted at act 1510 is not connected with the radio network node that transmitted the reporting configuration information (e.g., the user equipment is operating in an idle mode or an inactive mode), method 1500 advances to act 1525. If the reporting configuration information is transmitted at act 1510 via an SSB beam (e.g., MIB 905 indicates SIB 910 that may comprise, or that may indicate, information 915 as described in reference to FIG. 9), the user equipment may determine at act 1525 whether the information transmitted at act 1515 comprises a dynamic reporting mode indication in field 930. If field 930 of information 915 is not indicative of a dynamic reporting mode (e.g., field 930 indicates a static reporting mode), method 1500 advances to act 1535. At act 1535 the user equipment, which may be operating in an idle mode or an inactive mode, as described in reference to act 1520, may transmit a connection establishment request to the radio network node. The connection establishment request transmitted at act 1535 may comprise, or may be referred to as, a request for a reduced-capability connection to facilitate transmission from the user equipment to the radio network node in the uplink direction. At act 1540, the user equipment and radio network node may establish a connection in response to the request transmitted at act 1535. A connection established at act 1540 in response to a connection establishment request transmitted at act 1535 may be incapable of facilitating transmission of downlink traffic from the radio network node to the user equipment. Thus, a connection established at act 1540 in response to a request transmitted at act 1535 may be established for a limited purpose of the user equipment reporting measurement values measured at act 1515 and may not require scheduling, by the radio network node, of downlink frequency or timing resources to facilitate delivery of downlink traffic to the user equipment. At act 1545, the user equipment may transmit to the radio network node at least one signal strength parameter value corresponding to at least one measurement beam signal measurement made at act 1515. The at least one signal strength parameter value may be transmitted at act 1545 by the user equipment via a message 950 described in reference to FIG. 9. In at least one example embodiment, the at least one signal strength parameter value transmitted at act 1545 may comprise at least one measured signal strength value, at least one ratio of at least one measured signal strength value to noise or interference, or a statistical value corresponding to the at least one signal strength parameter value, for example a mean, an average, or a standard deviation. Because the user equipment was previously not operating in a connected mode with the radio network node as described in reference to act 1520, method 1500 advances from act 1550 to act 1585. At act 1585, the radio network node or the user equipment may flush context information corresponding to the connection established at act 1540 and may terminate the connection established at act 1540. Method 1500 advances from act 1585 to act 1590 and ends.

Returning to description of act 1525, if information received by an idle-mode user equipment that was transmitted at act 1510 indicates a dynamic reporting mode instead of a static reporting mode, method 1500 advances from act 1525 to act 1530 instead of advancing directly to act 1535, which would be the case if a determination is made at act 1525 that field 930, described in reference to FIG. 9, is indicative of a static mode. At act 1530, the idle-mode user equipment may determine whether a reporting criterion is satisfied before advancing to act 1535. For example, the user equipment may determine a difference between a signal strength corresponding to at least one measurement beam measured at act 1515 and a signal strength corresponding to an SSB beam with which the at least one measurement beam is associated (e.g., measurement beams 215 are associated with SSB beam 205A shown in FIG. 10). If the user equipment determines that a difference between an SSB beam signal strength and a signal strength value corresponding to the at least one measurement beam associated with the SSB beam does not equal or exceed a configured criterion, the user equipment may avoid requesting from the radio network node establishment of a connection and method 1500 may advance to act 1590 and end. Thus, for user equipment operating in an idle-mode that is/are close enough to a radio network node such that the user equipment does not determine much difference (e.g., a difference that does not equal or exceed a configured criterion) between the signal strength corresponding to at least one measurement beam and an SSB beam with which the at least one measurement beam is associated, the user equipment is likely close enough to the radio network node such that determining a delivery beam at 1555 for later use with the idle mode user equipment is not likely to result in better radio performance than if the radio network node does not determine a particular delivery beam according to an artificial intelligence delivery beam determining learning model to be used for potential future traffic delivery with the user equipment. Avoiding, by the user equipment, requesting establishment of a connection at act 1540 to transmit measured signal strength parameter values at act 1545 that may not result in a vastly superior delivery beam being determined with respect to the user equipment (as compared to conventional techniques or as compared to a delivery beam that might otherwise be determined at act 1545) may avoid radio and processing resources being used to establish the connection at act 1540 and may avoid radio and processing resources being used to transmit measured signal strength parameters at act 1545. If a determination is made at act 1530 that a difference between a signal strength corresponding to an SSB beam and at least one measurement beam measurement determined at act 1515 equals or exceeds a configured criterion, method 1500 advances to act 1535 and continues as described above. Thus, if a user is equipment is located with respect to a radio network node such that at least one measured signal strength value corresponding to at least one measurement beam and a signal strength corresponding to and SSB beam with which the at least one measurement beam is associated equals or exceeds the configured criterion, transmission of measurement beam measurement value(s) determined at act 1515 is likely to result in a delivery beam determined at 1555 improving radio performance with respect to the user equipment than if a refined delivery beam is not determined at act 1555, the user equipment may proceed to request establishment of a reduced-connection at act 1540 and transmit, at act 1545, instrument beam parameter measurement values determined at act 1515, which will likely result in a refined delivery beam being determined at act 1555 that will result in improved radio performance as compared to a delivery beam not being determined based on measurement beam parameter measurement values determined at act 1515. Accordingly, an indication of dynamic delivery mode in field 930 of information 915 may facilitate minimizing, or avoiding, radio resources and processor resources used to establish a connection between an idle-mode user equipment and a radio network node to transmit signal values measured at act 1515 that are not likely to enhance radio performance with respect to the idle-mode user equipment if the idle-mode user equipment determines in the future to request establishment of a full connection with the radio network node that will facilitate uplink and downlink delivery of data traffic in addition to delivery of control channel traffic.

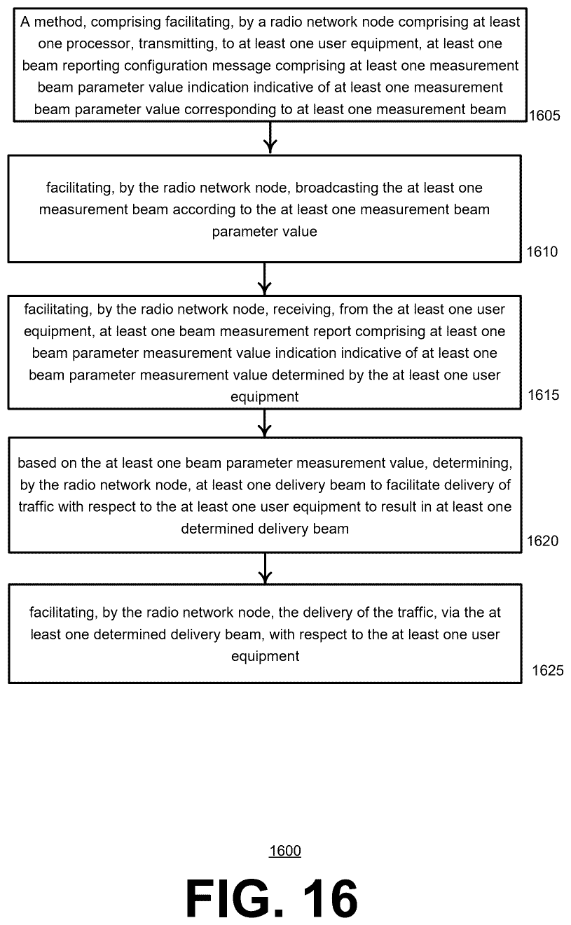

Turning now to FIG. 16, the figure illustrates an example embodiment method 1600 comprising at block 1605 facilitating, by a radio network node comprising at least one processor, transmitting, to at least one user equipment, at least one beam reporting configuration message comprising at least one measurement beam parameter value indication indicative of at least one measurement beam parameter value corresponding to at least one measurement beam; at block 1610 facilitating, by the radio network node, broadcasting the at least one measurement beam according to the at least one measurement beam parameter value; at block 1615 facilitating, by the radio network node, receiving, from the at least one user equipment, at least one beam measurement report comprising at least one beam parameter measurement value indication indicative of at least one beam parameter measurement value determined by the at least one user equipment; at block 1620 based on the at least one beam parameter measurement value, determining, by the radio network node, at least one delivery beam to facilitate delivery of traffic with respect to the at least one user equipment to result in at least one determined delivery beam; and at block 1625 facilitating, by the radio network node, the delivery of the traffic, via the at least one determined delivery beam, with respect to the at least one user equipment.

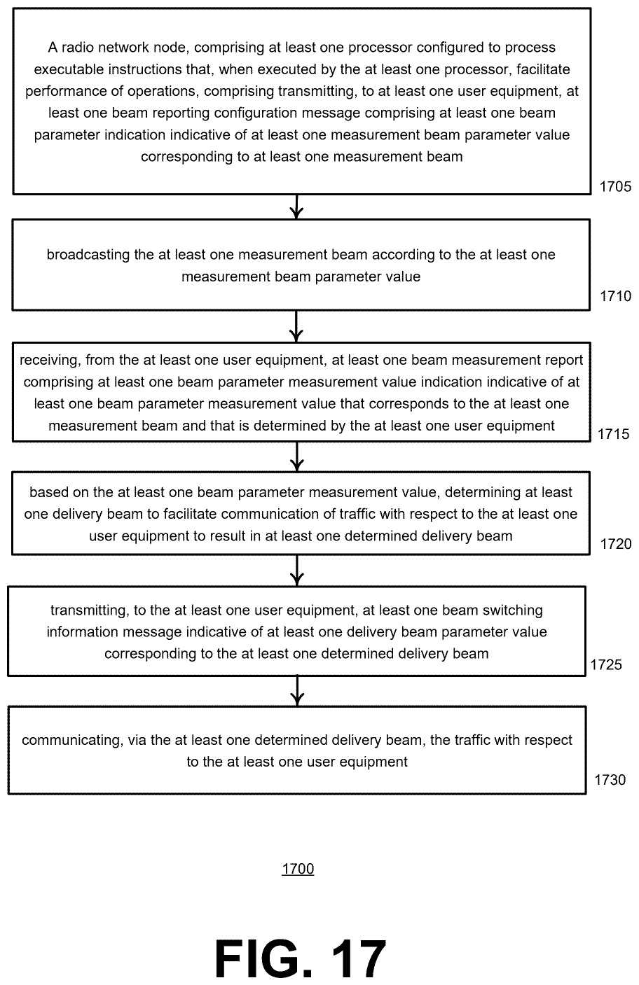

Turning now to FIG. 17, the figure illustrates a radio network node 1700, comprising at block 1705 at least one processor configured to process executable instructions that, when executed by the at least one processor, facilitate performance of operations, comprising transmitting, to at least one user equipment, at least one beam reporting configuration message comprising at least one beam parameter indication indicative of at least one measurement beam parameter value corresponding to at least one measurement beam; at block 1710 broadcasting the at least one measurement beam according to the at least one measurement beam parameter value; at block 1715 receiving, from the at least one user equipment, at least one beam measurement report comprising at least one beam parameter measurement value indication indicative of at least one beam parameter measurement value that corresponds to the at least one measurement beam and that is determined by the at least one user equipment; at block 1720 based on the at least one beam parameter measurement value, determining at least one delivery beam to facilitate communication of traffic with respect to the at least one user equipment to result in at least one determined delivery beam; at block 1725 transmitting, to the at least one user equipment, at least one beam switching information message indicative of at least one delivery beam parameter value corresponding to the at least one determined delivery beam; and at block 1730 communicating, via the at least one determined delivery beam, the traffic with respect to the at least one user equipment.

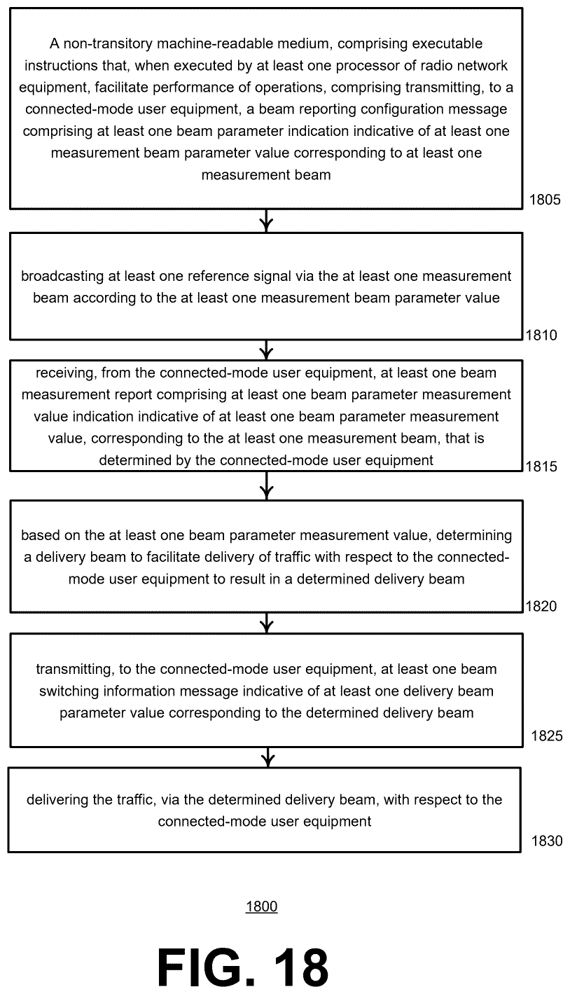

Turning now to FIG. 18, the figure illustrates a non-transitory machine-readable medium 1800 comprising at block 1805 executable instructions that, when executed by at least one processor of a radio network node, facilitate performance of operations, comprising, transmitting, to a connected-mode user equipment, a beam reporting configuration message comprising at least one beam parameter indication indicative of at least one measurement beam parameter value corresponding to at least one measurement beam; at block 1810 broadcasting at least one reference signal via the at least one measurement beam according to the at least one measurement beam parameter value; at block 1815 receiving, from the connected-mode user equipment, at least one beam measurement report comprising at least one beam parameter measurement value indication indicative of at least one beam parameter measurement value, corresponding to the at least one measurement beam, that is determined by the connected-mode user equipment; at block 1820 based on the at least one beam parameter measurement value, determining a delivery beam to facilitate delivery of traffic with respect to the connected-mode user equipment to result in a determined delivery beam; at block 1825 transmitting, to the connected-mode user equipment, at least one beam switching information message indicative of at least one delivery beam parameter value corresponding to the determined delivery beam; and at block 1830 delivering the traffic, via the determined delivery beam, with respect to the connected-mode user equipment.

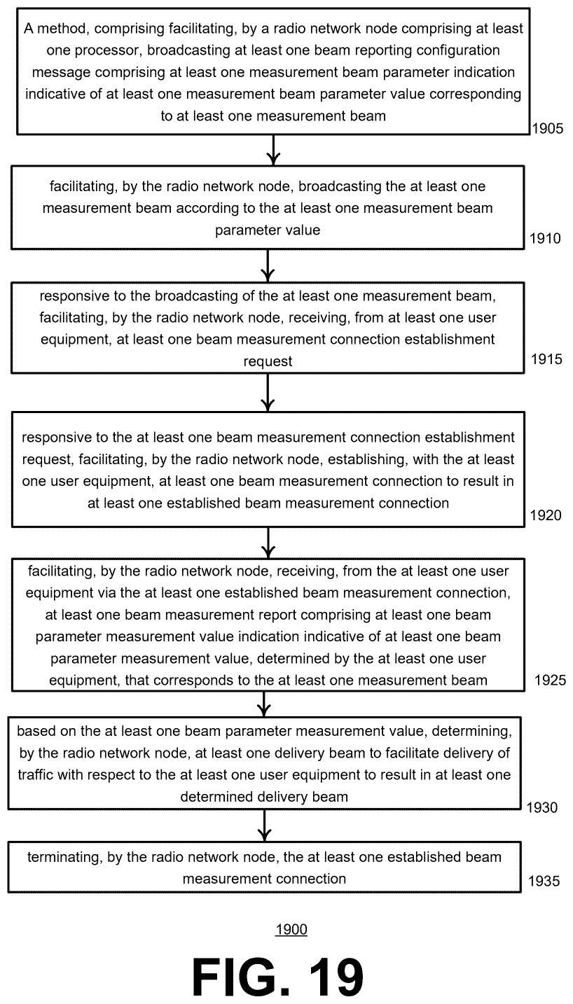

Turning now to FIG. 19, the figure illustrates an example embodiment method 1900 comprising at block 1905 facilitating, by a radio network node comprising at least one processor, broadcasting at least one beam reporting configuration message comprising at least one measurement beam parameter indication indicative of at least one measurement beam parameter value corresponding to at least one measurement beam; at block 1910 facilitating, by the radio network node, broadcasting the at least one measurement beam according to the at least one measurement beam parameter value; at block 1915 responsive to the broadcasting of the at least one measurement beam, facilitating, by the radio network node, receiving, from at least one user equipment, at least one beam measurement connection establishment request; at block 1920 responsive to the at least one beam measurement connection establishment request, facilitating, by the radio network node, establishing, with the at least one user equipment, at least one beam measurement connection to result in at least one established beam measurement connection; at block 1925 facilitating, by the radio network node, receiving, from the at least one user equipment via the at least one established beam measurement connection, at least one beam measurement report comprising at least one beam parameter measurement value indication indicative of at least one beam parameter measurement value, determined by the at least one user equipment, that corresponds to the at least one measurement beam; at block 1930 based on the at least one beam parameter measurement value, determining, by the radio network node, at least one delivery beam to facilitate delivery of traffic with respect to the at least one user equipment to result in at least one determined delivery beam; and at block 1935 terminating, by the radio network node, the at least one established beam measurement connection.

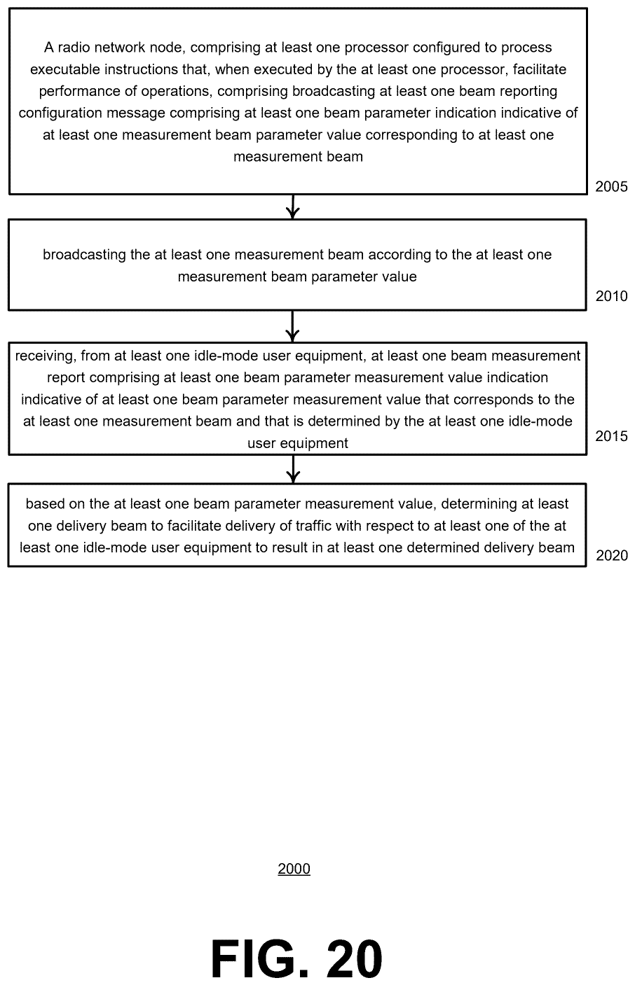

Turning now to FIG. 20, the figure illustrates a radio network node 2000, comprising at block 2005 at least one processor configured to process executable instructions that, when executed by the at least one processor, facilitate performance of operations, comprising broadcasting at least one beam reporting configuration message comprising at least one beam parameter indication indicative of at least one measurement beam parameter value corresponding to at least one measurement beam; at block 2010 broadcasting the at least one measurement beam according to the at least one measurement beam parameter value; at block 2015 receiving, from at least one idle-mode user equipment, at least one beam measurement report comprising at least one beam parameter measurement value indication indicative of at least one beam parameter measurement value that corresponds to the at least one measurement beam and that is determined by the at least one idle-mode user equipment; and at block 2020 based on the at least one beam parameter measurement value, determining at least one delivery beam to facilitate delivery of traffic with respect to at least one of the at least one idle-mode user equipment to result in at least one determined delivery beam.

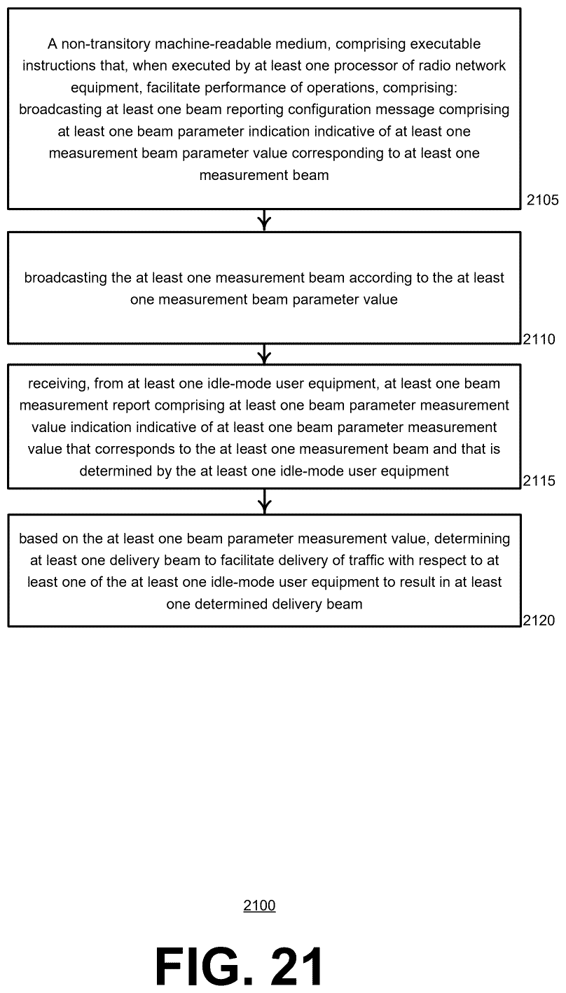

Turning now to FIG. 21, the figure illustrates a non-transitory machine-readable medium 2100 comprising at block 2105 executable instructions that, when executed by at least one processor of a radio network node, facilitate performance of operations, comprising, broadcasting at least one beam reporting configuration message comprising at least one beam parameter indication indicative of at least one measurement beam parameter value corresponding to at least one measurement beam; at block 2110 broadcasting the at least one measurement beam according to the at least one measurement beam parameter value; at block 2115 receiving, from at least one idle-mode user equipment, at least one beam measurement report comprising at least one beam parameter measurement value indication indicative of at least one beam parameter measurement value that corresponds to the at least one measurement beam and that is determined by the at least one idle-mode user equipment; and at block 2120 based on the at least one beam parameter measurement value, determining at least one delivery beam to facilitate delivery of traffic with respect to at least one of the at least one idle-mode user equipment to result in at least one determined delivery beam.

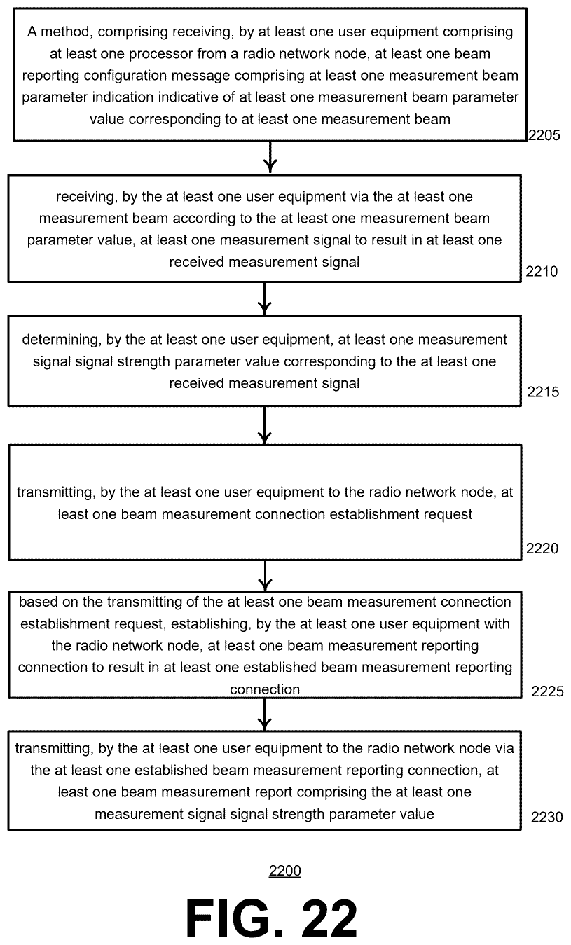

Turning now to FIG. 22, the figure illustrates an example embodiment method 2200 comprising at block 2205 receiving, by at least one user equipment comprising at least one processor from a radio network node, at least one beam reporting configuration message comprising at least one measurement beam parameter indication indicative of at least one measurement beam parameter value corresponding to at least one measurement beam; at block 2210 receiving, by the at least one user equipment via the at least one measurement beam according to the at least one measurement beam parameter value, at least one measurement signal to result in at least one received measurement signal; at block 2215 determining, by the at least one user equipment, at least one measurement signal signal strength parameter value corresponding to the at least one received measurement signal; at block 2220 transmitting, by the at least one user equipment to the radio network node, at least one beam measurement connection establishment request; at block 2225 based on the transmitting of the at least one beam measurement connection establishment request, establishing, by the at least one user equipment with the radio network node, at least one beam measurement reporting connection to result in at least one established beam measurement reporting connection; and at block 2230 transmitting, by the at least one user equipment to the radio network node via the at least one established beam measurement reporting connection, at least one beam measurement report comprising the at least one measurement signal signal strength parameter value.

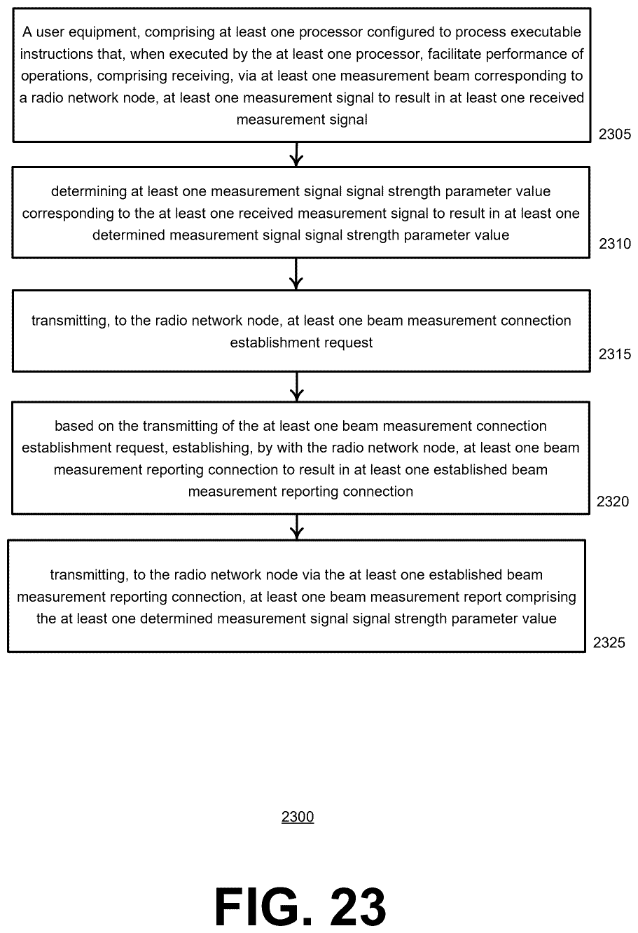

Turning now to FIG. 23, the figure illustrates a user equipment 2300, comprising at block 2305 at least one processor configured to process executable instructions that, when executed by the at least one processor, facilitate performance of operations, comprising receiving, via at least one measurement beam corresponding to a radio network node, at least one measurement signal to result in at least one received measurement signal; at block 2310 determining at least one measurement signal signal strength parameter value corresponding to the at least one received measurement signal to result in at least one determined measurement signal signal strength parameter value; at block 2315 transmitting, to the radio network node, at least one beam measurement connection establishment request; at block 2320 based on the transmitting of the at least one beam measurement connection establishment request, establishing, by with the radio network node, at least one beam measurement reporting connection to result in at least one established beam measurement reporting connection; and at block 2325 transmitting, to the radio network node via the at least one established beam measurement reporting connection, at least one beam measurement report comprising the at least one determined measurement signal signal strength parameter value.

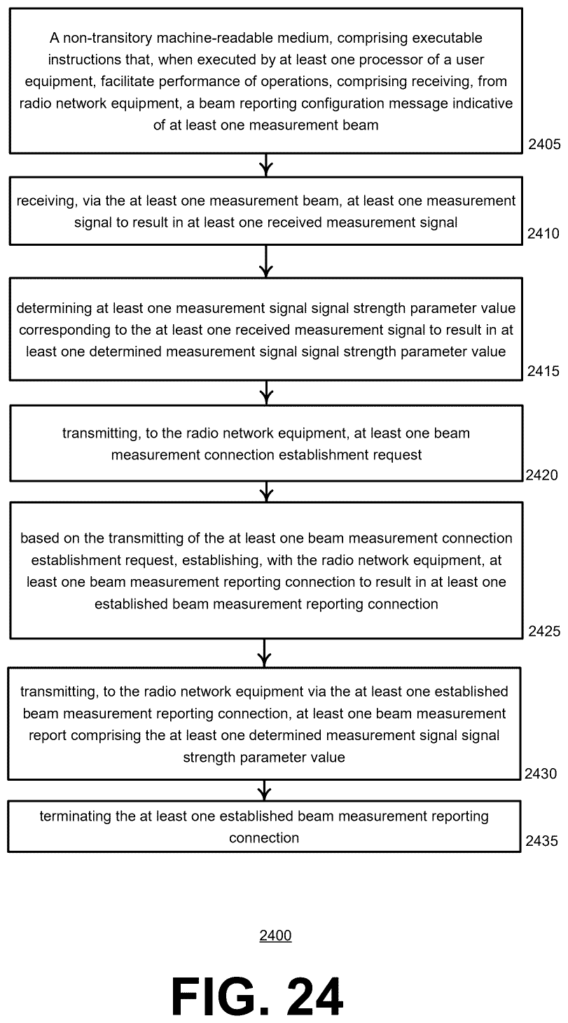

Turning now to FIG. 24, the figure illustrates a non-transitory machine-readable medium 2400 comprising at block 2405 executable instructions that, when executed by at least one processor of a user equipment, facilitate performance of operations, comprising, receiving, from radio network equipment, a beam reporting configuration message indicative of at least one measurement beam; at block 2410 receiving, via the at least one measurement beam, at least one measurement signal to result in at least one received measurement signal; at block 2415 determining at least one measurement signal signal strength parameter value corresponding to the at least one received measurement signal to result in at least one determined measurement signal signal strength parameter value; at block 2420 transmitting, to the radio network equipment, at least one beam measurement connection establishment request; at block 2425 based on the transmitting of the at least one beam measurement connection establishment request, establishing, with the radio network equipment, at least one beam measurement reporting connection to result in at least one established beam measurement reporting connection; at block 2430 transmitting, to the radio network equipment via the at least one established beam measurement reporting connection, at least one beam measurement report comprising the at least one determined measurement signal signal strength parameter value; and at block 2435 terminating the at least one established beam measurement reporting connection.

In order to provide additional context for various embodiments described herein, FIG. 25 and the following discussion are intended to provide a brief, general description of a suitable computing environment 2500 in which various embodiments of the embodiment described herein can be implemented. While embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 25, the example environment 2500 for implementing various embodiments described herein includes a computer 2502, the computer 2502 including a processing unit 2504, a system memory 2506 and a system bus 2508. The system bus 2508 couples system components including, but not limited to, the system memory 2506 to the processing unit 2504. The processing unit 2504 can be any of various commercially available processors and may include a cache memory. Dual microprocessors and other multi-processor architectures can also be employed as the processing unit 2504.

The system bus 2508 can be any of several types of bus structure that can further interconnect to a memory bus (with or without a memory controller), a peripheral bus, and a local bus using any of a variety of commercially available bus architectures. The system memory 2506 includes ROM 2510 and RAM 2512. A basic input/output system (BIOS) can be stored in a non-volatile memory such as ROM, erasable programmable read only memory (EPROM), EEPROM, which BIOS contains the basic routines that help to transfer information between elements within the computer 2502, such as during startup. The RAM 2512 can also include a high-speed RAM such as static RAM for caching data.

Computer 2502 further includes an internal hard disk drive (HDD) 2514 (e.g., EIDE, SATA), one or more external storage devices 2516 (e.g., a magnetic floppy disk drive (FDD) 2516, a memory stick or flash drive reader, a memory card reader, etc.) and an optical disk drive 2520 (e.g., which can read or write from a CD-ROM disc, a DVD, a BD, etc.). While the internal HDD 2514 is illustrated as located within the computer 2502, the internal HDD 2514 can also be configured for external use in a suitable chassis (not shown). Additionally, while not shown in environment 2500, a solid-state drive (SSD) could be used in addition to, or in place of, an HDD 2514. The HDD 2514, external storage device(s) 2516 and optical disk drive 2520 can be connected to the system bus 2508 by an HDD interface 2524, an external storage interface 2526 and an optical drive interface 2528, respectively. The interface 2524 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 2502, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 2512, including an operating system 2530, one or more application programs 2532, other program modules 2534 and program data 2536. All or portions of the operating system, applications, modules, and/or data can also be cached in the RAM 2512. The systems and methods described herein can be implemented utilizing various commercially available operating systems or combinations of operating systems.

Computer 2502 can optionally comprise emulation technologies. For example, a hypervisor (not shown) or other intermediary can emulate a hardware environment for operating system 2530, and the emulated hardware can optionally be different from the hardware illustrated in FIG. 25. In such an embodiment, operating system 2530 can comprise one virtual machine (VM) of multiple VMs hosted at computer 2502. Furthermore, operating system 2530 can provide runtime environments, such as the Java runtime environment or the .NET framework, for applications 2532. Runtime environments are consistent execution environments that allow applications 2532 to run on any operating system that includes the runtime environment. Similarly, operating system 2530 can support containers, and applications 2532 can be in the form of containers, which are lightweight, standalone, executable packages of software that include, e.g., code, runtime, system tools, system libraries and settings for an application.

Further, computer 2502 can comprise a security module, such as a trusted processing module (TPM). For instance, with a TPM, boot components hash next in time boot components, and wait for a match of results to secured values, before loading a next boot component. This process can take place at any layer in the code execution stack of computer 2502, e.g., applied at the application execution level or at the operating system (OS) kernel level, thereby enabling security at any level of code execution.

A user can enter commands and information into the computer 2502 through one or more wired/wireless input devices, e.g., a keyboard 2538, a touch screen 2540, and a pointing device, such as a mouse 2542. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 2504 through an input device interface 2544 that can be coupled to the system bus 2508, but can be connected by other interfaces, such as a parallel port, an IEEE 1394 serial port, a game port, a USB port, an IR interface, a BLUETOOTH® interface, etc.

A monitor 2546 or other type of display device can be also connected to the system bus 2508 via an interface, such as a video adapter 2548. In addition to the monitor 2546, a computer typically includes other peripheral output devices (not shown), such as speakers, printers, etc.

The computer 2502 can operate in a networked environment using logical connections via wired and/or wireless communications to one or more remote computers, such as a remote computer(s) 2550. The remote computer(s) 2550 can be a workstation, a server computer, a router, a personal computer, portable computer, microprocessor-based entertainment appliance, a peer device or other common network node, and typically includes many or all of the elements described relative to the computer 2502, although, for purposes of brevity, only a memory/storage device 2552 is illustrated. The logical connections depicted include wired/wireless connectivity to a local area network (LAN) 2554 and/or larger networks, e.g., a wide area network (WAN) 2556. Such LAN and WAN networking environments are commonplace in offices and companies, and facilitate enterprise-wide computer networks, such as intranets, all of which can connect to a global communications network, e.g., the internet.

When used in a LAN networking environment, the computer 2502 can be connected to the local network 2554 through a wired and/or wireless communication network interface or adapter 2558. The adapter 2558 can facilitate wired or wireless communication to the LAN 2554, which can also include a wireless access point (AP) disposed thereon for communicating with the adapter 2558 in a wireless mode.

When used in a WAN networking environment, the computer 2502 can include a modem 2560 or can be connected to a communications server on the WAN 2556 via other means for establishing communications over the WAN 2556, such as by way of the internet. The modem 2560, which can be internal or external and a wired or wireless device, can be connected to the system bus 2508 via the input device interface 2544. In a networked environment, program modules depicted relative to the computer 2502 or portions thereof, can be stored in the remote memory/storage device 2552. It will be appreciated that the network connections shown are examples and other means of establishing a communications link between the computers can be used.

When used in either a LAN or WAN networking environment, the computer 2502 can access cloud storage systems or other network-based storage systems in addition to, or in place of, external storage devices 2516 as described above. Generally, a connection between the computer 2502 and a cloud storage system can be established over a LAN 2554 or WAN 2556 e.g., by the adapter 2558 or modem 2560, respectively. Upon connecting the computer 2502 to an associated cloud storage system, the external storage interface 2526 can, with the aid of the adapter 2558 and/or modem 2560, manage storage provided by the cloud storage system as it would other types of external storage. For instance, the external storage interface 2526 can be configured to provide access to cloud storage sources as if those sources were physically connected to the computer 2502.

The computer 2502 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Turning now to FIG. 26, the figure illustrates a block diagram of an example UE 2660. UE 2660 may comprise a smart phone, a wireless tablet, a laptop computer with wireless capability, a wearable device, a machine device that may facilitate vehicle telematics, and the like. UE 2660 comprises a first processor 2630, a second processor 2632, and a shared memory 2634. UE 2660 includes radio front end circuitry 2662, which may be referred to herein as a transceiver, but is understood to typically include transceiver circuitry, separate filters, and separate antennas for facilitating transmission and receiving of signals over a wireless link, such as one or more wireless links 125, 135, or 137 shown in FIG. 1. Furthermore, transceiver 2662 may comprise multiple sets of circuitry or may be tunable to accommodate different frequency ranges, different modulations schemes, or different communication protocols, to facilitate long-range wireless links such as links, device-to-device links, such as links 135, and short-range wireless links, such as links 137.

Continuing with description of FIG. 26, UE 2660 may also include a SIM 2664, or a SIM profile, which may comprise information stored in a memory (memory 2634 or a separate memory portion), for facilitating wireless communication with RAN 105 or core network 130 shown in FIG. 1. FIG. 26 shows SIM 2664 as a single component in the shape of a conventional SIM card, but it will be appreciated that SIM 2664 may represent multiple SIM cards, multiple SIM profiles, or multiple eSIMs, some or all of which may be implemented in hardware or software. It will be appreciated that a SIM profile may comprise information such as security credentials (e.g., encryption keys, values that may be used to generate encryption keys, or shared values that are shared between SIM 2664 and another device, which may be a component of RAN 105 or core network 130 shown in FIG. 1). A SIM profile 2664 may also comprise identifying information that is unique to the SIM, or SIM profile, such as, for example, an International Mobile Subscriber Identity (“IMSI”) or information that may make up an IMSI.

SIM 2664 is shown coupled to both the first processor portion 2630 and the second processor portion 2632. Such an implementation may provide an advantage that first processor portion 2630 may not need to request or receive information or data from SIM 2664 that second processor 2632 may request, thus eliminating the use of the first processor acting as a ‘go-between’ when the second processor uses information from the SIM in performing its functions and in executing applications. First processor 2630, which may be a modem processor or baseband processor, is shown smaller than processor 2632, which may be a more sophisticated application processor, to visually indicate the relative levels of sophistication (i.e., processing capability and performance) and corresponding relative levels of operating power consumption levels between the two processor portions. Keeping the second processor portion 2632 asleep/inactive/in a low power state when UE 2660 does not need it for executing applications and processing data related to an application provides an advantage of reducing power consumption when the UE only needs to use the first processor portion 2630 while in listening mode for monitoring routine configured bearer management and mobility management/maintenance procedures, or for monitoring search spaces that the UE has been configured to monitor while the second processor portion remains inactive/asleep.

UE 2660 may also include sensors 2666, such as, for example, temperature sensors, accelerometers, gyroscopes, barometers, moisture sensors, and the like that may provide signals to the first processor 2630 or second processor 2632. Output devices 2668 may comprise, for example, one or more visual displays (e.g., computer monitors, VR appliances, and the like), acoustic transducers, such as speakers or microphones, vibration components, and the like. Output devices 2668 may comprise software that interfaces with output devices, for example, visual displays, speakers, microphones, touch sensation devices, smell or taste devices, and the like, that are external to UE 2660.

The following glossary of terms given in Table 1 may apply to one or more descriptions of embodiments disclosed herein.

TABLE 1

| Term | Definition |
|---|---|
| UE | User equipment |
| WTRU | Wireless transmit receive unit |
| RAN | Radio access network |
| QoS | Quality of service |
| DRX | Discontinuous reception |
| EPI | Early paging indication |
| DCI | Downlink control information |
| SSB | Synchronization signal block |
| RS | Reference signal |
| PDCCH | Physical downlink control channel |
| PDSCH | Physical downlink shared channel |
| MUSIM | Multi-SIM UE |
| SIB | System information block |
| MIB | Master information block |
| eMBB | Enhanced mobile broadband |
| URLLC | Ultra reliable and low latency communications |
| mMTC | Massive machine type communications |
| XR | Anything-reality |
| VR | Virtual reality |
| AR | Augmented reality |
| MR | Mixed reality |
| DCI | Downlink control information |
| DMRS | Demodulation reference signals |
| QPSK | Quadrature Phase Shift Keying |
| WUS | Wake up signal |
| HARQ | Hybrid automatic repeat request |
| RRC | Radio resource control |
| C-RNTI | Connected mode radio network temporary identifier |
| CRC | Cyclic redundancy check |
| MIMO | Multi input multi output |
| UE | User equipment |
| CBR | Channel busy ratio |
| SCI | Sidelink control information |
| SBFD | Sub-band full duplex |
| CLI | Cross link interference |
| TDD | Time division duplexing |
| FDD | Frequency division duplexing |
| BS | Base-station |
| RS | Reference signal |
| CSI-RS | Channel state information reference signal |
| PTRS | Phase tracking reference signal |
| DMRS | Demodulation reference signal |
| gNB | General NodeB |
| PUCCH | Physical uplink control channel |
| PUSCH | Physical uplink shared channel |
| SRS | Sounding reference signal |
| NES | Network energy saving |
| QCI | Quality class indication |
| RSRP | Reference signal received power |
| PCI | Primary cell ID |
| BWP | Bandwidth Part |

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” or variations thereof as may be used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
receiving, by at least one user equipment comprising at least one processor from a radio network node, at least one beam reporting configuration message comprising at least one measurement beam parameter indication indicative of at least one measurement beam parameter value corresponding to at least one measurement beam;
receiving, by the at least one user equipment via the at least one measurement beam according to the at least one measurement beam parameter value, at least one measurement signal to result in at least one received measurement signal;
determining, by the at least one user equipment, at least one measurement signal signal strength parameter value corresponding to the at least one received measurement signal;
transmitting, by the at least one user equipment to the radio network node, at least one beam measurement connection establishment request;
based on the transmitting of the at least one beam measurement connection establishment request, establishing, by the at least one user equipment with the radio network node, at least one beam measurement reporting connection to result in at least one established beam measurement reporting connection; and
transmitting, by the at least one user equipment to the radio network node via the at least one established beam measurement reporting connection, at least one beam measurement report comprising the at least one measurement signal signal strength parameter value.

2. The method of claim 1, wherein the at least one beam measurement connection establishment request comprises at least one request for a reduced-capability connection, wherein the at least one established beam measurement reporting connection is at least one reduced-capability connection capable of facilitating the receiving the at least one beam measurement report, and wherein the at least one reduced-capability connection is not capable of facilitating transmitting downlink traffic to the at least one user equipment.

3. The method of claim 1, further comprising:
transmitting, by the at least one user equipment, at least one traffic delivery connection establishment request;
responsive to the at least one traffic delivery connection establishment request, establishing, by the at least one user equipment, at least one full-capability connection with the at least one user equipment corresponding to at least one determined delivery beam determined by the radio network node based on the at least one measurement signal signal strength parameter value; and
receiving, by the at least one user equipment from the radio network node via the at least one determined delivery beam and via the at least one full-capability connection, traffic.

4. The method of claim 1, wherein the at least one user equipment comprises a first user equipment, and wherein the method further comprises:
transmitting, by a second user equipment of the at least one user equipment, a traffic delivery connection establishment request;
based on the transmitting of the traffic delivery connection establishment request, establishing, by the second user equipment, a full-capability connection with the radio network node according to at least one determined delivery beam determined by the radio network node based on the at least one measurement signal signal strength parameter value; and
receiving, by the second user equipment from the radio network node via the at least one determined delivery beam and via the full-capability connection, traffic.

5. The method of claim 4, wherein the first user equipment and the second user equipment are geographically located within a geographic range of one another corresponding to a beam width associated with the at least one determined delivery beam.

6. The method of claim 4, wherein the at least one beam reporting configuration message is received via a synchronization signal block beam corresponding to a synchronization signal block beam direction, and wherein the at least one measurement beam corresponds to at least one measurement beam direction that is associated with the synchronization signal block beam direction.

7. The method of claim 6, wherein the at least one beam measurement report further comprises at least one synchronization signal block beam indication indicative of the synchronization signal block beam that corresponds to the at least one measurement beam, and wherein the at least one determined delivery beam is determined by the radio network node based on the at least one synchronization signal block beam indication.

8. The method of claim 1, wherein the at least one beam reporting configuration message comprises at least one beam measurement mode indication indicative of a dynamic reporting mode according to which the at least one user equipment is to avoid the transmitting the at least one beam measurement connection establishment request unless the at least one user equipment determines that the at least one measurement signal signal strength parameter value, which corresponds to the at least one measurement beam, satisfies a measurement beam reporting criterion.

9. The method of claim 8, further comprising:
measuring, by the at least one user equipment, at least one synchronization signal block signal strength parameter value corresponding to at least one synchronization signal block signal corresponding to at least one synchronization signal block beam associated with the radio network node to result in at least one measured synchronization signal block signal strength parameter value;
based on the at least one measured synchronization signal block signal strength parameter value, determining, by the at least one user equipment, a synchronization signal block beam of the at least one synchronization signal block beam that corresponds to a best measured synchronization signal block signal strength parameter value of the at least one measured synchronization signal block signal strength parameter value to result in a determined best synchronization signal block beam;
analyzing, by the at least one user equipment, the at least one measurement signal signal strength parameter value with respect to the best measured synchronization signal block signal strength parameter value to result in a signal strength parameter difference value; and
analyzing, by the at least one user equipment, the signal strength parameter difference value with respect to a configured measurement beam reporting criterion to result in an analyzed signal strength parameter difference value,
wherein the transmitting of the at least one beam measurement connection establishment request is based on the analyzed signal strength parameter difference value being determined, by the at least one user equipment, to satisfy the configured measurement beam reporting criterion.

10. The method of claim 9, wherein the measurement beam reporting criterion comprises at least one of: a first criterion based on a difference, or a second criterion based on a standard deviation, with respect to at least one of which the at least one user equipment is to analyze a first measurement value corresponding to the at least one measurement signal signal strength parameter value corresponding to the at least one measurement beam and a second measurement value corresponding to the determined best synchronization signal block beam.

11. The method of claim 1, further comprising:
ranking, by the at least one user equipment, the at least one measurement beam in descending order according to the at least one measurement signal signal strength parameter value to result in a measurement beam ranking order, wherein the at least one beam measurement report is further indicative of the measurement beam ranking order.

12. The method of claim 1, wherein the at least one measurement signal signal strength parameter value comprises at least one of: at least one signal strength value corresponding to the at least one measurement beam or at least one ratio of the at least one signal strength value with respect to at least one of at least one noise value or at least one interference value determined by the at least one user equipment.

13. The method of claim 1, wherein the at least one beam reporting configuration message is further indicative of at least one of a timing resource indication or at least one frequency resource indication indicative, respectively, of at least one timing resource or at least one frequency resource corresponding to the at least one measurement beam.

14. The method of claim 1, wherein the at least one measurement beam parameter value comprises at least one of: at least one quantity of the at least one measurement beam, at least one angular direction indication indicative of at least one direction corresponding to the at least one measurement beam, or at least one gain indication indicative of at least one beam gain corresponding to the at least one measurement beam.

15. The method of claim 1, wherein the at least one beam reporting configuration message comprises at least one beam measurement mode indication indicative of a static reporting mode according to which the transmitting of the at least one beam measurement connection establishment request is to be responsive to the receiving of the at least one beam reporting configuration message.

16. A user equipment, comprising at least one processor configured to process executable instructions that, when executed by the at least one processor, facilitate performance of operations, comprising
receiving, via at least one measurement beam corresponding to a radio network node, at least one measurement signal to result in at least one received measurement signal;
determining at least one measurement signal signal strength parameter value corresponding to the at least one received measurement signal to result in at least one determined measurement signal signal strength parameter value;
transmitting, to the radio network node, at least one beam measurement connection establishment request;
based on the transmitting of the at least one beam measurement connection establishment request, establishing, by with the radio network node, at least one beam measurement reporting connection to result in at least one established beam measurement reporting connection; and
transmitting, to the radio network node via the at least one established beam measurement reporting connection, at least one beam measurement report comprising the at least one determined measurement signal signal strength parameter value.

17. The user equipment of claim 16, wherein the operations further comprise:
measuring at least one synchronization signal block signal strength parameter value corresponding to at least one synchronization signal block signal corresponding to at least one synchronization signal block beam associated with the radio network node to result in at least one measured synchronization signal block signal strength parameter value;
based on the at least one measured synchronization signal block signal strength parameter value, determining a synchronization signal block beam of the at least one synchronization signal block beam that corresponds to a best measured synchronization signal block signal strength parameter value of the at least one measured synchronization signal block signal strength parameter value to result in a determined best synchronization signal block beam;
analyzing the at least one determined measurement signal signal strength parameter value with respect to the best measured synchronization signal block signal strength parameter value to result in a signal strength parameter difference value; and
analyzing the signal strength parameter difference value with respect to a configured measurement beam reporting criterion to result in an analyzed signal strength parameter difference value,
wherein the transmitting of the at least one beam measurement connection establishment request is based on the analyzed signal strength parameter difference value being determined, by the user equipment, to satisfy the configured measurement beam reporting criterion.

18. The user equipment of claim 16, wherein the operations further comprise ranking, by the user equipment, the at least one measurement beam according to the at least one determined measurement signal signal strength parameter value to result in a measurement beam ranking order, and wherein the at least one beam measurement report is further indicative of the measurement beam ranking order.

19. A non-transitory machine-readable medium, comprising executable instructions that, when executed by at least one processor of a user equipment, facilitate performance of operations, comprising:
receiving, from radio network equipment, a beam reporting configuration message indicative of at least one measurement beam;
receiving, via the at least one measurement beam, at least one measurement signal to result in at least one received measurement signal;
determining at least one measurement signal signal strength parameter value corresponding to the at least one received measurement signal to result in at least one determined measurement signal signal strength parameter value;
transmitting, to the radio network equipment, at least one beam measurement connection establishment request;
based on the transmitting of the at least one beam measurement connection establishment request, establishing, with the radio network equipment, at least one beam measurement reporting connection to result in at least one established beam measurement reporting connection;
transmitting, to the radio network equipment via the at least one established beam measurement reporting connection, at least one beam measurement report comprising the at least one determined measurement signal signal strength parameter value; and
terminating the at least one established beam measurement reporting connection.

20. The non-transitory machine-readable medium of claim 19, wherein the operations further comprise:
transmitting, to the radio network equipment, at least one traffic delivery connection establishment request;
responsive to the at least one traffic delivery connection establishment request, establishing, with the radio network equipment, a full-capability connection according to at least one determined delivery beam determined by the radio network equipment based on the at least one determined measurement signal signal strength parameter value; and
communicating, with the radio network equipment, traffic using the at least one determined delivery beam.
